(19) United States
(12) Patent Application Publication
(10) Pub. No.: US 2026/0046752 A1
(43) Pub. Date: Feb. 12, 2026

(54) ADAPTIVE REMAINING MINIMUM SYSTEM INFORMATION COMBINING

(71) Applicant: QUALCOMM Incorporated, San Diego, CA (US)

(72) Inventors: Mostafa KHOSHNEVISAN, San Diego, CA (US); Yan ZHOU, San Diego, CA (US)

(21) Appl. No.: 18/797,347

(22) Filed: Aug. 7, 2024

(51) Int. Cl. H04W 48/16; H04L 5/00; H04W 48/12

(52) U.S. Cl. CPC H04W 48/16; H04L 5/0048; H04W 48/12

(57) ABSTRACT

Methods, systems, and devices for wireless communications are described. Remaining minimum system information (RMSI) may include information for a user equipment (UE) to access a cell. The network may transmit multiple repetitions of RMSI with an RMSI period in accordance with an RMSI periodicity, and UE may use (e.g., may combine) the multiple repetitions of RMSI to correctly decode RMSI as each RMSI within a same RMSI period may be expected to have the same RMSI payload. The RMSI periodicity (e.g., the length of the RMSI period) may be dynamically extended, or multiple RMSI periods may be bunded together to enable the UE to combine RMSI messages received over a longer period of time to decode the RMSI.

### FIELD OF TECHNOLOGY

The following relates to wireless communications, including adaptive remaining minimum system information combining.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving remaining minimum system information (RMSI) via a first RMSI message during an RMSI period in accordance with a dynamic RMSI periodicity, receiving the RMSI via a second RMSI message during the RMSI period in accordance with the dynamic RMSI periodicity, and decoding the RMSI from the first RMSI message and the second RMSI message based on both of the first RMSI message and the second RMSI message being received within the dynamic RMSI periodicity.

A UE for wireless communications is described. The UE may include one or more memories storing processor executable code, and one or more processors coupled with the one or more memories. The one or more processors may individually or collectively be operable to execute the code to cause the UE to receive RMSI via a first RMSI message during an RMSI period in accordance with a dynamic RMSI periodicity, receive the RMSI via a second RMSI message during the RMSI period in accordance with the dynamic RMSI periodicity, and decode the RMSI from the first RMSI message and the second RMSI message based on both of the first RMSI message and the second RMSI message being received within the dynamic RMSI periodicity.

Another UE for wireless communications is described. The UE may include means for receiving RMSI via a first RMSI message during an RMSI period in accordance with a dynamic RMSI periodicity, means for receiving the RMSI via a second RMSI message during the RMSI period in accordance with the dynamic RMSI periodicity, and means for decoding the RMSI from the first RMSI message and the second RMSI message based on both of the first RMSI message and the second RMSI message being received within the dynamic RMSI periodicity.

A non-transitory computer-readable medium storing code for wireless communications is described. The code may include instructions executable by one or more processors to receive RMSI via a first RMSI message during an RMSI period in accordance with a dynamic RMSI periodicity, receive the RMSI via a second RMSI message during the RMSI period in accordance with the dynamic RMSI periodicity, and decode the RMSI from the first RMSI message and the second RMSI message based on both of the first RMSI message and the second RMSI message being received within the dynamic RMSI periodicity.

Some examples of the method, UEs, and non-transitory computer-readable medium described herein may further include operations, features, means, or instructions for receiving a control message that indicates the dynamic RMSI periodicity from a set of candidate RMSI periodicities.

In some examples of the method, UEs, and non-transitory computer-readable medium described herein, receiving the control message may include operations, features, means, or instructions for receiving the control message including a single bit field that indicates the dynamic RMSI periodicity from the set of candidate RMSI periodicities, the set of candidate RMSI periodicities including two candidate RMSI periodicities and receiving the control message including a two bit field that indicates the dynamic RMSI periodicity from the set of candidate RMSI periodicities, the set of candidate RMSI periodicities including four candidate RMSI periodicities.

In some examples of the method, UEs, and non-transitory computer-readable medium described herein, the set of candidate RMSI periodicities may be based on an operating frequency band associated with the RMSI or a multiplexing pattern associated with synchronization signal blocks (SSBs).

In some examples of the method, UEs, and non-transitory computer-readable medium described herein, the control message may be a master information block (MIB), the MIB indicates first scheduling information for a physical downlink control channel transmission, and the physical downlink control channel transmission indicates second scheduling information for the first RMSI message.

Some examples of the method, UEs, and non-transitory computer-readable medium described herein may further include operations, features, means, or instructions for determining the dynamic RMSI periodicity based on an operating frequency band associated with the RMSI or a multiplexing pattern associated with SSBs.

Some examples of the method, UEs, and non-transitory computer-readable medium described herein may further include operations, features, means, or instructions for performing, based on decoding the RMSI, a random access channel procedure with a cell, where the first RMSI message and the second RMSI message may be both received from the cell.

In some examples of the method, UEs, and non-transitory computer-readable medium described herein, the dynamic RMSI periodicity may be greater than 160 milliseconds.

In some examples of the method, UEs, and non-transitory computer-readable medium described herein, decoding the RMSI may include operations, features, means, or instructions for performing a soft combination of a first set of coded bits associated with the first RMSI message and a second set of coded bits associated with the second RMSI message.

In some examples of the method, UEs, and non-transitory computer-readable medium described herein, the first RMSI message and the second RMSI message may be associated with a same payload based on both of the first RMSI message and the second RMSI message being received within the dynamic RMSI periodicity.

A method for wireless communications by a network entity is described. The method may include outputting, to a UE, an RMSI via a first RMSI message during an RMSI period in accordance with a dynamic RMSI periodicity and outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

A network entity for wireless communications is described. The network entity may include one or more memories storing processor executable code, and one or more processors coupled with the one or more memories. The one or more processors may individually or collectively be operable to execute the code to cause the network entity to output, to a UE, an RMSI via a first RMSI message during an RMSI period in accordance with a dynamic RMSI periodicity and output, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

Another network entity for wireless communications is described. The network entity may include means for outputting, to a UE, an RMSI via a first RMSI message during an RMSI period in accordance with a dynamic RMSI periodicity and means for outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

A non-transitory computer-readable medium storing code for wireless communications is described. The code may include instructions executable by one or more processors to output, to a UE, an RMSI via a first RMSI message during an RMSI period in accordance with a dynamic RMSI periodicity and output, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

Some examples of the method, network entities, and non-transitory computer-readable medium described herein may further include operations, features, means, or instructions for outputting, to the UE, a control message that indicates the dynamic RMSI periodicity from a set of candidate RMSI periodicities.

In some examples of the method, network entities, and non-transitory computer-readable medium described herein, outputting the control message may include operations, features, means, or instructions for outputting the control message including a single bit field that indicates the dynamic RMSI periodicity from the set of candidate RMSI periodicities, the set of candidate RMSI periodicities including two candidate RMSI periodicities and outputting the control message including a two bit field that indicates the dynamic RMSI periodicity from the set of candidate RMSI periodicities, the set of candidate RMSI periodicities including four candidate RMSI periodicities.

In some examples of the method, network entities, and non-transitory computer-readable medium described herein, the set of candidate RMSI periodicities may be based on an operating frequency band associated with the RMSI or a multiplexing pattern associated with SSBs.

In some examples of the method, network entities, and non-transitory computer-readable medium described herein, the control message may be a MIB, the MIB indicates first scheduling information for a physical downlink control channel transmission, and, and the physical downlink control channel transmission indicates second scheduling information for the first RMSI message.

In some examples of the method, network entities, and non-transitory computer-readable medium described herein, the dynamic RMSI periodicity may be based on an operating frequency band associated with the RMSI or a multiplexing pattern associated with SSBs.

In some examples of the method, network entities, and non-transitory computer-readable medium described herein, the dynamic RMSI periodicity may be greater than 160 milliseconds.

A method for wireless communications by a UE is described. The method may include receiving RMSI via a first RMSI message during a first RMSI period in accordance with an RMSI periodicity, receiving the RMSI via a second RMSI message during a second RMSI period in accordance with the RMSI periodicity, where the second RMSI period is subsequent to and contiguous with the first RMSI period, receiving a control message that indicates that the first RMSI period is bundled with the second RMSI period, and decoding the RMSI from the first RMSI message and the second RMSI message based on the control message.

A UE for wireless communications is described. The UE may include one or more memories storing processor executable code, and one or more processors coupled with the one or more memories. The one or more processors may individually or collectively be operable to execute the code to cause the UE to receive RMSI via a first RMSI message during a first RMSI period in accordance with an RMSI periodicity, receive the RMSI via a second RMSI message during a second RMSI period in accordance with the RMSI periodicity, where the second RMSI period is subsequent to and contiguous with the first RMSI period, receive a control message that indicates that the first RMSI period is bundled with the second RMSI period, and decode the RMSI from the first RMSI message and the second RMSI message based on the control message.

Another UE for wireless communications is described. The UE may include means for receiving RMSI via a first RMSI message during a first RMSI period in accordance with an RMSI periodicity, means for receiving the RMSI via a second RMSI message during a second RMSI period in accordance with the RMSI periodicity, where the second RMSI period is subsequent to and contiguous with the first RMSI period, means for receiving a control message that indicates that the first RMSI period is bundled with the second RMSI period, and means for decoding the RMSI from the first RMSI message and the second RMSI message based on the control message.

A non-transitory computer-readable medium storing code for wireless communications is described. The code may include instructions executable by one or more processors to receive RMSI via a first RMSI message during a first RMSI period in accordance with an RMSI periodicity, receive the RMSI via a second RMSI message during a second RMSI period in accordance with the RMSI periodicity, where the second RMSI period is subsequent to and contiguous with the first RMSI period, receive a control message that indicates that the first RMSI period is bundled with the second RMSI period, and decode the RMSI from the first RMSI message and the second RMSI message based on the control message.

In some examples of the method, UEs, and non-transitory computer-readable medium described herein, receiving the control message may include operations, features, means, or instructions for receiving the control message during the first RMSI period, where the control message includes a field that indicates that the first RMSI period may be bundled with a subsequent and contiguous RMSI period.

Some examples of the method, UEs, and non-transitory computer-readable medium described herein may further include operations, features, means, or instructions for receiving a set of multiple control messages during the first RMSI period, where the set of multiple control messages indicate respective scheduling information for a set of multiple respective RMSI messages during the first RMSI period, where the set of multiple respective RMSI messages includes the first RMSI message, and where the control message may be a temporally last control message of the set of multiple control messages.

In some examples of the method, UEs, and non-transitory computer-readable medium described herein, the control message includes one of downlink control information (DCI) that indicates scheduling information for the first RMSI period or a MIB.

In some examples of the method, UEs, and non-transitory computer-readable medium described herein, receiving the control message may include operations, features, means, or instructions for receiving the control message during the second RMSI period, where the control message includes a field that indicates that the second RMSI period may be bundled with a prior and contiguous RMSI period.

Some examples of the method, UEs, and non-transitory computer-readable medium described herein may further include operations, features, means, or instructions for receiving a set of multiple control messages during the second RMSI period, where the set of multiple control messages indicate respective scheduling information for a set of multiple respective RMSI messages during the second RMSI period, where the set of multiple respective RMSI messages includes the first RMSI message, and where the control message may be a temporally first control message of the set of multiple control messages.

In some examples of the method, UEs, and non-transitory computer-readable medium described herein, the control message includes one of DCI that indicates scheduling information for the second RMSI period or a MIB.

In some examples of the method, UEs, and non-transitory computer-readable medium described herein, receiving the control message may include operations, features, means, or instructions for receiving second DCI that includes second scheduling information for the second RMSI message, where a second new data indicator field of the second DCI indicates a same value as a first new data indicator field of first DCI that includes first scheduling information for the first RMSI message.

Some examples of the method, UEs, and non-transitory computer-readable medium described herein may further include operations, features, means, or instructions for receiving, during one of the first RMSI period or the second RMSI period, a set of multiple control messages, where the set of multiple control messages includes the control message, and where each of the set of multiple control messages indicates that the first RMSI period may be bundled with the second RMSI period or each of the set of multiple control messages indicates that the first RMSI period may be not bundled with the second RMSI period.

Some examples of the method, UEs, and non-transitory computer-readable medium described herein may further include operations, features, means, or instructions for decoding the RMSI from the first RMSI message and the second RMSI message may be based on an operating frequency band associated with the RMSI or a multiplexing pattern associated with SSBs.

Some examples of the method, UEs, and non-transitory computer-readable medium described herein may further include operations, features, means, or instructions for performing, based on decoding the RMSI, a random access channel procedure with a cell, where the first RMSI message and the second RMSI message may be both received from the cell.

In some examples of the method, UEs, and non-transitory computer-readable medium described herein, decoding the RMSI may include operations, features, means, or instructions for performing a soft combination of a first set of coded bits associated with the first RMSI message and a second set of coded bits associated with the second RMSI message.

In some examples of the method, UEs, and non-transitory computer-readable medium described herein, the first RMSI message and the second RMSI message may be associated with a same payload based on the control message.

A method for wireless communications by a network entity is described. The method may include outputting, to a UE, an RMSI via a first RMSI message during a first RMSI period in accordance with an RMSI periodicity, outputting, to the UE, the RMSI via a second RMSI message during a second RMSI period in accordance with the RMSI periodicity, where the second RMSI period is subsequent to and contiguous with the first RMSI period, and transmitting, to the UE, a control message that indicates that the first RMSI period is bundled with the second RMSI period, where the first RMSI message has a same payload as the second RMSI message based on the control message.

A network entity for wireless communications is described. The network entity may include one or more memories storing processor executable code, and one or more processors coupled with the one or more memories. The one or more processors may individually or collectively be operable to execute the code to cause the network entity to output, to a UE, an RMSI via a first RMSI message during a first RMSI period in accordance with an RMSI periodicity, output, to the UE, the RMSI via a second RMSI message during a second RMSI period in accordance with the RMSI periodicity, where the second RMSI period is subsequent to and contiguous with the first RMSI period, and transmit, to the UE, a control message that indicates that the first RMSI period is bundled with the second RMSI period, where the first RMSI message has a same payload as the second RMSI message based on the control message.

Another network entity for wireless communications is described. The network entity may include means for outputting, to a UE, an RMSI via a first RMSI message during a first RMSI period in accordance with an RMSI periodicity, means for outputting, to the UE, the RMSI via a second RMSI message during a second RMSI period in accordance with the RMSI periodicity, where the second RMSI period is subsequent to and contiguous with the first RMSI period, and means for transmitting, to the UE, a control message that indicates that the first RMSI period is bundled with the second RMSI period, where the first RMSI message has a same payload as the second RMSI message based on the control message.

A non-transitory computer-readable medium storing code for wireless communications is described. The code may include instructions executable by one or more processors to output, to a UE, an RMSI via a first RMSI message during a first RMSI period in accordance with an RMSI periodicity, output, to the UE, the RMSI via a second RMSI message during a second RMSI period in accordance with the RMSI periodicity, where the second RMSI period is subsequent to and contiguous with the first RMSI period, and transmit, to the UE, a control message that indicates that the first RMSI period is bundled with the second RMSI period, where the first RMSI message has a same payload as the second RMSI message based on the control message.

In some examples of the method, network entities, and non-transitory computer-readable medium described herein, outputting the control message may include operations, features, means, or instructions for outputting the control message during the first RMSI period, where the control message includes a field that indicates that the first RMSI period may be bundled with a subsequent and contiguous RMSI period.

Some examples of the method, network entities, and non-transitory computer-readable medium described herein may further include operations, features, means, or instructions for outputting a set of multiple control messages during the first RMSI period, where the set of multiple control messages indicate respective scheduling information for a set of multiple respective RMSI messages during the first RMSI period, where the set of multiple respective RMSI messages includes the first RMSI message, and where the control message may be a temporally last control message of the set of multiple control messages.

In some examples of the method, network entities, and non-transitory computer-readable medium described herein, the control message includes one of DCI that indicates scheduling information for the first RMSI period or a MIB.

In some examples of the method, network entities, and non-transitory computer-readable medium described herein, outputting the control message may include operations, features, means, or instructions for outputting the control message during the second RMSI period, where the control message includes a field that indicates that the second RMSI period may be bundled with a prior and contiguous RMSI period.

Some examples of the method, network entities, and non-transitory computer-readable medium described herein may further include operations, features, means, or instructions for outputting a set of multiple control messages during the second RMSI period, where the set of multiple control messages indicate respective scheduling information for a set of multiple respective RMSI messages during the second RMSI period, where the set of multiple respective RMSI messages includes the first RMSI message, and where the control message may be a temporally first control message of the set of multiple control messages.

In some examples of the method, network entities, and non-transitory computer-readable medium described herein, the control message includes one of DCI that indicates scheduling information for the second RMSI period or a MIB.

Some examples of the method, network entities, and non-transitory computer-readable medium described herein may further include operations, features, means, or instructions for outputting, during one of the first RMSI period or the second RMSI period, a set of multiple control messages, where the set of multiple control messages includes the control message, and where each of the set of multiple control messages indicates that the first RMSI period may be bundled with the second RMSI period or each of the set of multiple control messages indicates that the first RMSI period may be not bundled with the second RMSI period.

In some examples of the method, network entities, and non-transitory computer-readable medium described herein, outputting the control message may include operations, features, means, or instructions for outputting second DCI that includes second scheduling information for the second RMSI message, where a second new data indicator field of the second DCI indicates a same value as a first new data indicator field of first DCI that includes first scheduling information for the first RMSI message.

In some examples of the method, network entities, and non-transitory computer-readable medium described herein, the first RMSI message having the same payload as the second RMSI message may be based on an operating frequency band associated with the RMSI or a multiplexing pattern associated with SSBs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports adaptive remaining minimum system information (RMSI) combining in accordance with one or more aspects of the present disclosure.

FIG. 2 shows an example of a synchronization signal block (SSB) resource diagram that supports that supports adaptive RMSI combining in accordance with one or more aspects of the present disclosure.

FIG. 3 shows an example of diagrams of SSB and RMSI multiplexing patterns that supports adaptive RMSI combining in accordance with one or more aspects of the present disclosure.

FIG. 4 shows an example of a wireless communications system that supports adaptive RMSI combining in accordance with one or more aspects of the present disclosure.

FIG. 5 shows an example of an SSB and RMSI periodicity diagram that supports adaptive RMSI combining in accordance with one or more aspects of the present disclosure.

FIG. 6 shows an example of an SSB and RMSI periodicity diagram that supports adaptive RMSI combining in accordance with one or more aspects of the present disclosure.

FIG. 7 shows an example of a process flow that supports adaptive RMSI combining in accordance with one or more aspects of the present disclosure.

FIG. 8 shows an example of a process flow that supports adaptive RMSI combining in accordance with one or more aspects of the present disclosure.

FIGS. 9 and 10 show block diagrams of devices that support adaptive RMSI combining in accordance with one or more aspects of the present disclosure.

FIG. 11 shows a block diagram of a communications manager that supports adaptive RMSI combining in accordance with one or more aspects of the present disclosure.

FIG. 12 shows a diagram of a system including a device that supports adaptive RMSI combining in accordance with one or more aspects of the present disclosure.

FIGS. 13 and 14 show block diagrams of devices that support adaptive RMSI combining in accordance with one or more aspects of the present disclosure.

FIG. 15 shows a block diagram of a communications manager that supports adaptive RMSI combining in accordance with one or more aspects of the present disclosure.

FIG. 16 shows a diagram of a system including a device that supports adaptive RMSI combining in accordance with one or more aspects of the present disclosure.

FIGS. 17 through 20 show flowcharts illustrating methods that support adaptive RMSI combining in accordance with one or more aspects of the present disclosure.

### DETAILED DESCRIPTION

In wireless communications systems, a user equipment (UE) may monitor for synchronization signal blocks (SSBs) from a cell to perform cell or beam search and/or selection. A cell may transmit SSBs via multiple beams (e.g., may perform beam sweeping of SSBs), and the UE may measure the SSBs to select a cell and beam to access based on the measurements of the SSBs. An SSB may be transmitted over four symbols. An SSB may include a primary synchronization signal (PSS) in a first symbol, a physical broadcast channel (PBCH) transmitted over the subsequent three symbols, and a secondary synchronization signal (SSS) multiplexed with the PBCH transmission on the third symbol. The PSS and the SSS together may indicate the cell ID (e.g., the physical cell identifier (PCI)) of the cell that transmitted the SSB. The UE also may use the PSS and SSS to synchronize timing with the cell and to decode the PBCH transmission. The PBCH may convey a master information block (MIB) for the cell which may include an indication of a physical downlink control channel (PDCCH) occasion to monitor. The PDCCH in the indicated PDCCH occasion may include scheduling information for a physical downlink shared channel (PDSCH) transmission that conveys remaining minimum system information (RMSI) (e.g., a system information block one (SIB1)) for the cell. The RMSI may be used to perform an access procedure with the cell (e.g., to perform a random access channel (RACH) procedure with the cell).

RMSI and SSBs may be periodically transmitted. In some examples, to save power at the network, RMSI may be transmitted less frequently than the SSBs. The coding rate of RMSI may be high, and thus the UE may be able to decode the SSB but may not be able to decode RMSI under some channel conditions. A UE may use repetitions of RMSI received within an RMSI period in order to correctly decode the RMSI, as each repetition of an RMSI message within an RMSI period may be expected to convey the same RMSI. In some examples, a maximum RMSI period may be 160 milliseconds (ms), and up to 8 RMSI message repetitions may be transmitted within 160 ms. Based on the high coding rate of RMSI and the limited resources assigned to RMSI (e.g., two symbols), even with multiple repetitions, the UE may demand a high signal to noise ratio (SNR) in order to correctly decode the RMSI payload.

Aspects of the disclosure relate to extending the RMSI period (e.g., using a longer RMSI periodicity) and/or bundling multiple RMSI periods in order to enable the UE to combine RMSI messages received over a longer period of time to decode the RMSI. In some examples, the RMSI periodicity (e.g., the length of the RMSI periods during which the UE can expect the RMSI in RMSI messages to be the same) may be dynamic. For example, the RMSI periodicity may depend on an operating frequency of the UE or the SSB multiplexing pattern. In some examples, the network may dynamically indicate, for example, in the MIB, the dynamic RMSI periodicity. In some examples, the network may indicate whether consecutive RMSI periods may be bundled (e.g., can be expected to have the same RMSI). For example, the MIB or the PDCCH that schedules the RMSI within a given RMSI period may indicate whether that RMSI period is bundled with a previous RMSI period or a next RMSI period.

Aspects of the disclosure are initially described in the context of wireless communications systems. Aspects of the disclosure are further illustrated by and described with reference to SSB resource diagrams, diagrams of SSB and RMSI multiplexing patterns, SSB and RMSI periodicity diagrams, process flows, apparatus diagrams, system diagrams, and flowcharts that relate to SSB and remaining SI multiplexing patterns.

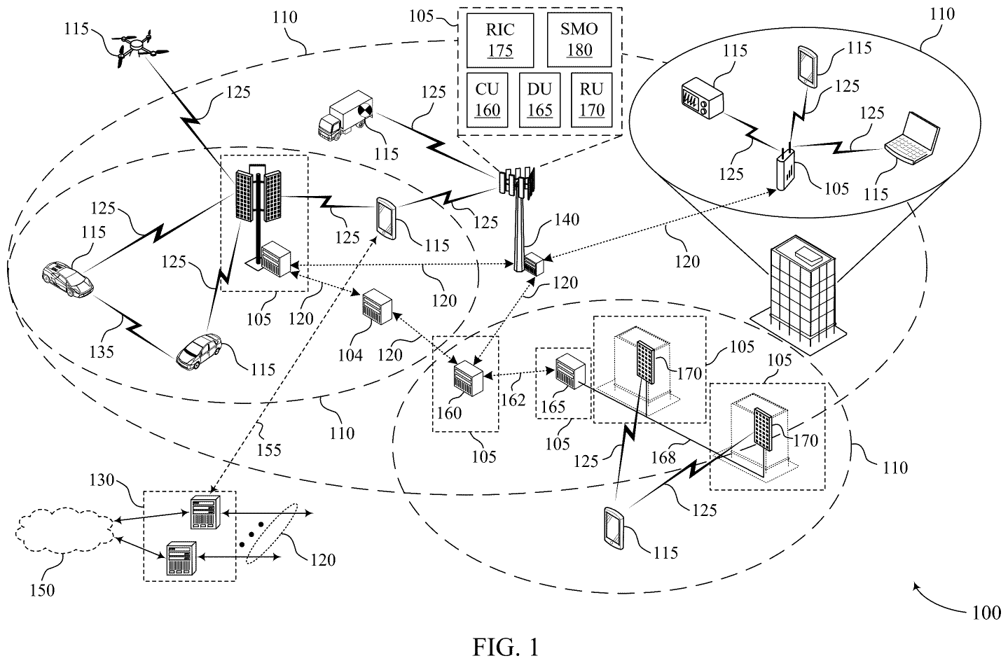

FIG. 1 shows an example of a wireless communications system 100 that supports adaptive RMSI combining in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest SNR, or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, a UE 115 may monitor for SSBs from a cell (e.g., transmitted by a network entity 105) as a part of an initial cell search. The PSS and the SSS of an SSB together may indicate the cell ID (e.g., the PCI) of the cell that transmitted the SSB. The UE 115 also may use the PSS and SSS to synchronize timing with the cell and to decode the PBCH transmission of the SSB. The PBCH transmission may convey MIB which may include system information (SI) for the cell and may include scheduling information for a PDCCH occasion for the UE 115 to monitor. The PDCCH transmission in the indicated PDCCH occasion may include scheduling information for a PDSCH transmission that includes RMSI for the cell. The RMSI may be used to perform an access procedure with the cell (e.g., a RACH procedure). RMSI and SSBs may be periodically transmitted. In some examples, to save power at the network entity 105, RMSI may be transmitted less frequently than the SSBs. The coding rate of RMSI may be higher than the coding rate of SSBs (e.g., the code rate of the MIB/PBCH of the SSBs), and thus the UE 115 may be able to decode the SSB but may not be able to decode RMSI under some channel conditions. A UE 115 may use repetitions of RMSI received within an RMSI period in order to correctly decode the RMSI, as each repetition of an RMSI message within an RMSI period may be expected to convey the same RMSI. Based on the high coding rate of RMSI and the limited resources assigned to RMSI (e.g., two symbols), even with multiple repetitions, the UE 115 may demand a high minimum demanded SNR in order to correctly decode the RMSI payload, which may limit the coverage range of the cell (UEs 115 with SNR smaller than the minimum demanded SNR may not be able to decode the RMSI).

In some examples, the RMSI period may be extended and/or RMSI periods bundled to enable the UE 115 to combine RMSI messages received over a longer period of time to decode the RMSI. In some examples, the RMSI periodicity (e.g., the length of the RMSI periods during which the UE 115 can expect the RMSI in RMSI messages to be the same) may be dynamic. For example, the RMSI periodicity may depend on an operating frequency of the UE 115 (e.g., frequency range 1 (FR1) or frequency range 2 (FR2)) or the SSB multiplexing pattern (e.g., multiplexing pattern between SSB and CORESET0). In some examples, the network may dynamically indicate, for example, in the MIB, the dynamic RMSI periodicity. In some examples, the network may indicate whether consecutive RMSI periods may be bundled (e.g., can be expected to have the same RMSI payload). For example, the MIB or the PDCCH that schedules the RMSI within a given RMSI period may indicate whether that RMSI period is bundled with a previous RMSI period or a next RMSI period.

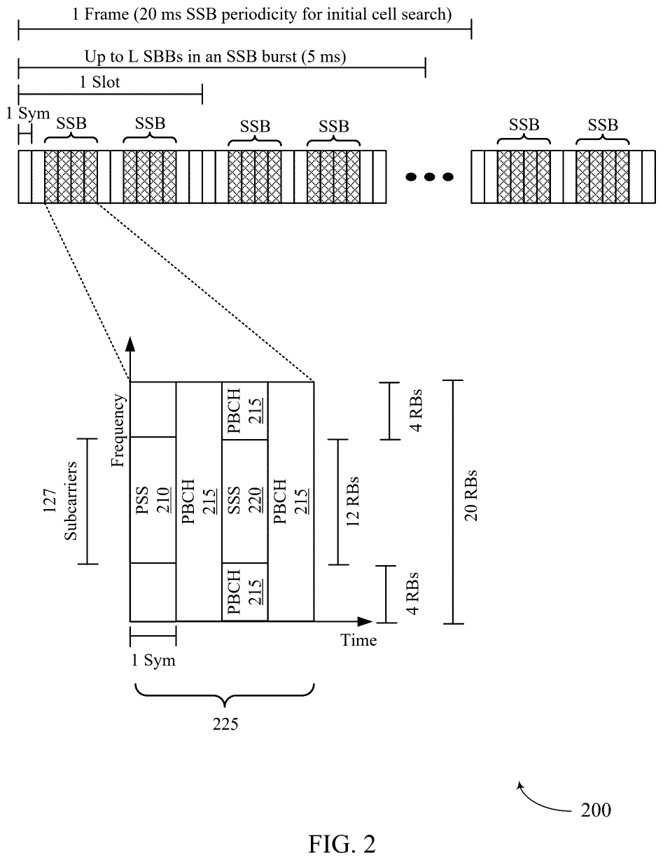

FIG. 2 shows an example of an SSB resource diagram 200 that supports adaptive RMSI combining in accordance with one or more aspects of the present disclosure. The SSB resource diagram 200 may implement or may be implemented by aspects of the wireless communications system 100.

As described herein, an SSB 225 may include four symbols and may include a PSS 210, a PBCH transmission 215, and an SSS 220. The PSS 210 may be transmitted in a temporally first symbol of the SSB 225, the PBCH transmission 215 may be transmitted in the next three symbols of the SSB 225, and the SSS 220 may be frequency-division multiplexed with the PBCH transmission 215 on the temporally third symbol of the SSB 225. For example, the PSS 210 may be transmitted on 127 subcarriers in the temporally first symbol (e.g., twelve resource blocks (RBs)). In the temporally second symbol and the temporally fourth symbol of the SSB 225, the PBCH transmission 215 may be transmitted over 20 RBs. In the temporally third symbol of the SSB 225, the SSS 220 may be transmitted over the middle twelve RBs, and the PBCH transmission 215 may be transmitted on four RBs higher in frequency than the middle twelve RBs and four RBs lower in frequency than the middle twelve RBs.

A cell may periodically transmit SSBs 225 via multiple beams, and the UE 115 may measure the SSBs to select a cell and beam to access. For example, the cell may transmit a burst of SSBs via multiple beams, which the UE 115 may measure to select a cell and beam. For example, as shown in the SSB resource diagram 200, a cell may transmit multiple SSBs (e.g., two as shown in FIG. 2) per slot, and may transmit up to L SSBs in an SSB burst (e.g., a five ms burst). A cell may periodically transmit SSB bursts in accordance with an SSB periodicity, (e.g., one burst per two radio frames (e.g., 20 ms)). For example, the SSB periodicity may be 20 ms.

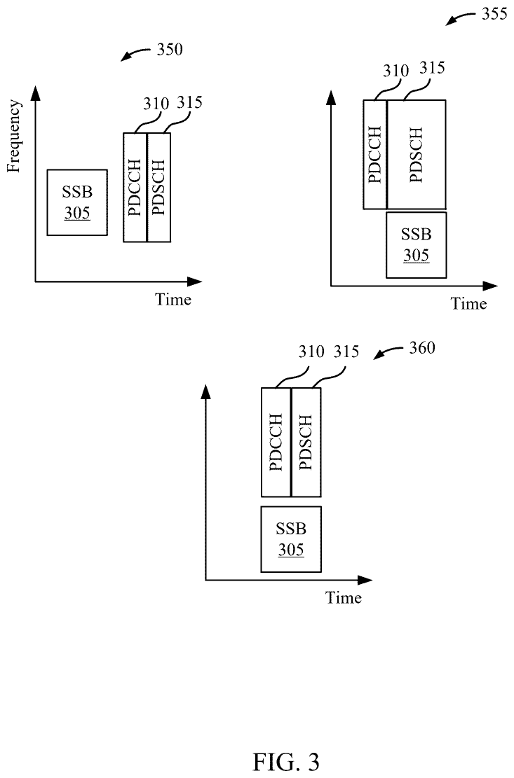

FIG. 3 shows an example diagram 350 of an SSB and RMSI multiplexing pattern, an example diagram 355 of an SSB and RMSI multiplexing pattern, and an example diagram 360 of an SSB and RMSI multiplexing pattern that support adaptive RMSI combining in accordance with one or more aspects of the present disclosure. The diagram 350, the diagram 355, and the diagram 360 may implement or may be implemented by aspects of the wireless communications system 100.

Multiple multiplexing patterns may be used for SSBs 305 and corresponding PDCCH transmissions 310 and PDSCH transmissions 315. The corresponding PDCCH transmissions 310 may include scheduling information for the corresponding PDSCH transmissions 315. The corresponding PDSCH transmissions 315 may include RMSI (e.g., a SIB1) for the cell. A PDSCH transmission 315 which includes RMSI for the cell may be referred to as an RMSI PDSCH transmission. The PDCCH transmission 310 may be associated with Type0 common search space (CSS). A default type0 CSS may be a search space set #0 (SSS0) that is associated with CORESET0. The PDSCH transmissions 315 that conveys the RMSI may be periodically broadcast every 160 ms with repetition up to every 20 ms (the network may determine which of the 8 repetitions within every 160 ms RMSI period are transmitted). A downlink control information (DCI) format 1_0 conveyed via the PDCCH transmissions 310 may schedule the corresponding PDSCH transmission 315 that conveys the RMSI. The DCI format 1_0 may include a cyclic redundancy check scrambled by a SI radio network temporary identifier (SI-RNTI). The UE 115 may monitor the Type0-CSS for the PDCCH transmissions 310 that conveys the DCI format 1_0 that schedules the PDSCH transmission 315.

In a first multiplexing pattern as shown in the diagram 350, the PDCCH transmission 310 may follow the SSB 305 (e.g., the MIB in the SSB 305 may indicate a later resource for the PDCCH). In a second multiplexing pattern as shown in the diagram 355, the PDCCH transmission 310 may be prior to the SSB 305 and the PDSCH transmission 315 may be frequency division multiplexed with the SSB 305. For example, in the second multiplexing pattern as shown in the diagram 355, the MIB in the SSB 305 may indicate a resource for the PDCCH transmission 310 which is prior in time to the SSB 305. In a third multiplexing pattern as shown in the diagram 360, the PDCCH transmission 310 and the PDSCH transmission 315 may be frequency division multiplexed with the SSB 305. For example, in the third multiplexing pattern as shown in the diagram 360, the MIB in the SSB 305 may indicate a resource for the PDCCH transmission 310 which is overlapping in time with the SSB 305. For example, in the second multiplexing pattern as shown in the diagram 355 and the third multiplexing pattern as shown in the diagram 360, the UE 115 may monitor for the PDCCH transmission 310 and may buffer received PDCCH transmissions, and the SSB 305 may indicate a concurrent or past resource for the PDCCH transmission 310, which the UE 115 may identify in the buffer.

In some examples, the second and third multiplexing patterns may be used in FR2 (e.g., frequency bands from 24.25 GHz to 71.0 GHZ) to reduce broadcast channel overhead due to analog beam constraints by frequency division multiplexing the SSB 305 and the corresponding PDCCH transmission 310 and PDSCH transmission 315 associated with the RMSI. In the second multiplexing pattern as shown in the diagram 355, the PDCCH transmission 310 may be transmitted over one symbol and the PDSCH transmission 315 may be transmitted over two symbols using a 120 kHz subcarrier spacing (SCS). In the second multiplexing pattern as shown in the diagram 355, the two symbols of the PDSCH transmission 315 may be frequency division multiplexed with the four symbols of the SSB where the SSB uses a 240 kHz SCS. In the second multiplexing pattern as shown in the diagram 355, four SSBs may be packed into each slot.

In the third multiplexing pattern as shown in the diagram 360, the PDCCH transmission 310 and the PDSCH transmission 315 may each be transmitted over two symbols using a 120 kHz SCS. In the third multiplexing pattern as shown in the diagram 360, the PDCCH transmission 310 and the PDSCH transmission 315 may be frequency division multiplexed with the four symbols of the SSB where the SSB uses a 120 kHz SCS. In the third multiplexing pattern as shown in the diagram 360, two SSBs may be packed into each slot.

The PDSCH transmission 315 may convey RMSI for the cell. RMSI may include the minimum configuration information for the UE to perform initial access with the cell. The payload of the RMSI may vary from 800 to 1500 bits (e.g., based on the vendor of the network entity 105). For example, Table 1 shows an example of the SIB1 transmission strategy for several example vendors and Table 2 shows an example of the other system information (OSI) strategy for the example vendors. System information blocks (SIBs) other than SIB1 (e.g., other than RMSI) such as SIB2-9 (e.g., OSIBs) may be delivered upon request by a UE 115. OSIBs may be conveyed via a PDSCH transmission 315 scheduled by a PDCCH transmission associated with the TypeOA-CSS.

TABLE 1

| | | Modulation and | |
|---|---|---|---|
| | Resource Blocks | Coding Scheme | Transport Block |
| Vendor | (RBs) | (MCS) | (TB) Size (Bytes) |
| Vendor 1 | 16 | 5 | 177 |
| Vendor 2 | 13 | 4 | 123 |
| Vendor 3 | 28 | 0 | 101 |

TABLE 2

| | | Resource | Modulation | Transport |
|---|---|---|---|---|
| | SIB Mapping | Blocks | and Coding | Block (TB) |
| Vendor | Pattern | (RBs) | Scheme (MCS) | Size (Bytes) |
| Vendor 1 | SIB2 + SIB4 | 4 | 5 | 44 |
| Vendor 1 | SIB5 | 20 | 5 | 225 |
| Vendor 2 | SIB2 + SIB3 + | 22 | 0 | 80 |
| | SIB5 | | | |
| Vendor 3 | SIB2 + SIB5 | 12 | 0 | 42 |

The quantity of symbols for the PDSCH transmission 315 that conveys the RMSI may be limited to two symbols in the second and third multiplexing patterns as described herein, which may affect the coverage of the PDSCH transmission 315 that conveys the RMSI. For example, for the second multiplexing pattern with a 1500 bit RMSI payload size and 24 resource blocks (RBs) used to convey the PDSCH transmission 315, the UE 115 may demand a ten dB SNR at 1% block error rate (BLER) in order to decode the RMSI. Thus, even with eight repetitions of the RMSI (e.g., which is the maximum within a 160 ms RMSI periodicity), the UE 115 may demand a −3 dB SNR at 1% BLER in order to decode the RMSI.

Accordingly, the network entity 105 may transmit PDSCH transmissions 315 which convey the same RMSI (e.g., the same RMSI payload) in an RMSI period (e.g., 160 ms in NR) so that the UE 115 may soft combine the RMSI from the different PDSCH transmissions. Given an RMSI periodicity of 160, and given an SSB periodicity of 20 ms, the maximum quantity of RMSI repetitions within a 160 ms RMSI period may be eight. Eight repetitions of RMSI may be insufficient under some conditions. For example, eight repetitions may be insufficient for cell-edge UEs 115. Further, transmission of eight PDSCH transmissions 315 conveying RMSI within each RMSI period (e.g., transmission of a maximum quantity of RMSI repetitions) may involve high energy consumption at the network entity 105. RMSI for a given cell may change infrequently (e.g., may change less frequently than every 160 ms). Accordingly, an assumption of a 160 ms RMSI periodicity may be unnecessarily limiting for soft combining purposes at the UE 115. Accordingly, as described herein, the RMSI period may be extended and/or RMSI periods bundled to enable the UE 115 to combine RMSI messages received over a longer period of time to decode the RMSI. Note that the 160 ms default RMSI periodicity assumed here is an example, and the techniques described related to adaptive or dynamic RMSI periodicity, FR or multiplexing pattern dependent RMSI periodicity, or bundling one or more RMSI periodicity may be applicable and beneficial even when the default RMSI periodicity is smaller or larger than the 160 ms.

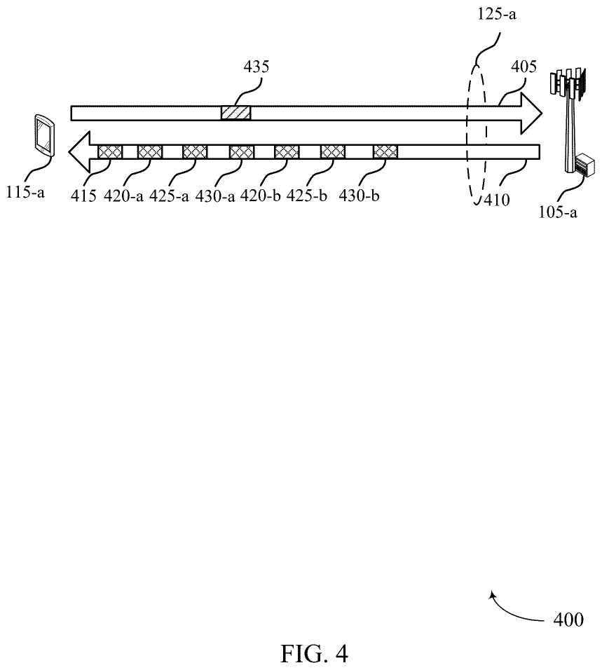

FIG. 4 shows an example of a wireless communications system 400 that supports adaptive RMSI combining in accordance with one or more aspects of the present disclosure. The wireless communications system 400 may implement or may be implemented by aspects of the wireless communications system 100. For example, the wireless communications system 400 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 405, such as uplink control signals or uplink data signals, to the network entity 105-a using the communication link 125-a, and the network entity 105-a may transmit downlink signals 410, such as downlink control signals or downlink data signals, to the UE 115-a using the communication link 125-a.

The network entity 105-a may transmit SSBs 420. The SSBs 420 may include a PSS, an SSS, and a PBCH transmission as described herein. The PSS and the SSS of the SSB 420 together may indicate the cell ID, and the UE 115-a also may use the PSS and SSS to synchronize timing with the cell and to decode the PBCH transmission of the SSB 420. The PBCH transmission may convey a MIB which may include SI for the cell and may include scheduling information for a PDCCH occasion to monitor (e.g., may indicate a control resource set (CORESET) and/or a search space to monitor for the PDCCH transmission 425). The PDCCH transmission 425 in the indicated PDCCH occasion may include scheduling information for an RMSI PDSCH transmission 430 (e.g., a PDSCH transmission that includes RMSI). The UE 115-a may use the SSB 420 and the RMSI conveyed via the RMSI PDSCH transmission 430 to perform initial access with the network entity 105-a. For example, the UE 115-a may measure multiple SSBs 420 transmitted by the network entity 105-a, and based on the measurements may select the cell and beam associated with the SSB 420. The UE 115-a may identify a RACH occasion in which to transmit a RACH message 435 (e.g., a msg1 or a msgA) based on the information in the MIB and/or the information in the RMSI conveyed via the RMSI PDSCH transmission 430.

In some examples, the UE 115-a may use (e.g., may perform soft combining) repetitions of RMSI conveyed via the multiple RMSI PDSCH transmissions 430 to decode the RSMI. For example, network entity 105-a may transmit RMSI PDSCH transmissions 430 which convey the same RMSI (e.g., the same RMSI payload) which the UE 115-a may soft-combine to decode the RMSI. For example, an SSB 420-a may include a MIB which may include scheduling information for the PDCCH transmission 425-a. The PDCCH transmission 425-a may include scheduling information for the RMSI PDSCH transmission 430-a, which may convey a first repetition of the RMSI. In some examples, the SSB 420-b may include a MIB which may include scheduling information for the PDCCH transmission 425-b. In some examples, a UE 115-a may decode a MIB once, and then may monitor for the PDCCH in CORESET0 one or more times based on the configurations of the CORESET0 and/or the SSS0. For example, the UE 115-a may monitor for the PDCCH transmission 425-b based on the CORESET0 configuration indicated in the MIB in the SSB 420-a. The PDCCH transmission 425-b may include scheduling information for the RMSI PDSCH transmission 430-b, which may convey a second repetition of the RMSI. The UE 115-a may perform a soft-combination of the RMSI PDSCH transmission 430-a and the RMSI PDSCH transmission 430-b to decode the RMSI conveyed via the RMSI PDSCH transmission 430-a and the RMSI PDSCH transmission 430-b. In order to perform the soft-combination of the RMSI PDSCH transmission 430-a and the RMSI PDSCH transmission 430-b, the RMSI PDSCH transmission 430-a and the RMSI PDSCH transmission 430-b may convey the same RMSI. As described herein, RMSI PDSCHs within the same RMSI period may convey the same RMSI. In some examples, the RMSI periodicity may be extended in order to enable the UE 115-a to combine RMSI messages received over a longer period of time to decode the RMSI. For example, the RMSI PDSCH transmission 430-a and the RMSI PDSCH transmission 430-b may be received over a period of time longer than 160 ms. In some examples, consecutive RMSI periods may be bundled to enable the UE 115-a to combine RMSI messages received over a longer period of time to decode the RMSI.

In some examples, the RMSI periodicity may be based on a fixed assumption. For example, the RMSI periodicity may be based on the operating band of the UE 115-a (e.g., the band in which the SSB 420 is received). As another example, the RMSI periodicity may be based on the SSB multiplexing pattern (e.g., multiplexing pattern one, multiplexing pattern two, or multiplexing pattern three as described with reference to FIG. 3). In such examples, the UE 115-a may assume that all RMSI PDSCH transmissions 430 convey the same RMSI (e.g., have the same payload) and accordingly may be soft combined to enhance coverage. For example, the fixed assumption may be a 320 ms RMSI periodicity for FR2 and a 160 ms RMSI periodicity for FR1 (e.g., sub-6 GHz frequency bands). As another example, the fixed assumption may be a 320 ms RMSI periodicity for the second and third multiplexing patterns as described with reference to FIG. 3 and a 160 ms RMSI periodicity for the first multiplexing pattern as described with reference to FIG. 3. The multiplexing pattern in FR2 may be indicated in the MIB in the SSB as part of the CORESET0 configuration. The boundary of an RMSI period may be defined with respect to the system frame number (SFN) (e.g., the start of a period may be a frame with SFN mod (RMSI periodicity in ms/0)=0).

In some examples, the network entity 105-a may transmit a control message 415 which may indicate the RMSI periodicity. In some examples, the MIB in an SSB 420 may indicate the RMSI periodicity.

In some examples, the control message 415 may indicate that one RMSI period is bundled with another RMSI period. In some examples, the MIB in an SSB 420 may indicate that the RMSI period in which the SSB 420 is received is bundled with another RMSI period (e.g., either the previous or the next consecutive RMSI period). In some examples, the PDCCH transmission 425 that schedules an RMSI PDSCH transmission 430 may indicate that the that the RMSI period in which the PDCCH transmission 425 is received is bundled with another RMSI period (e.g., either the previous or the next consecutive RMSI period).

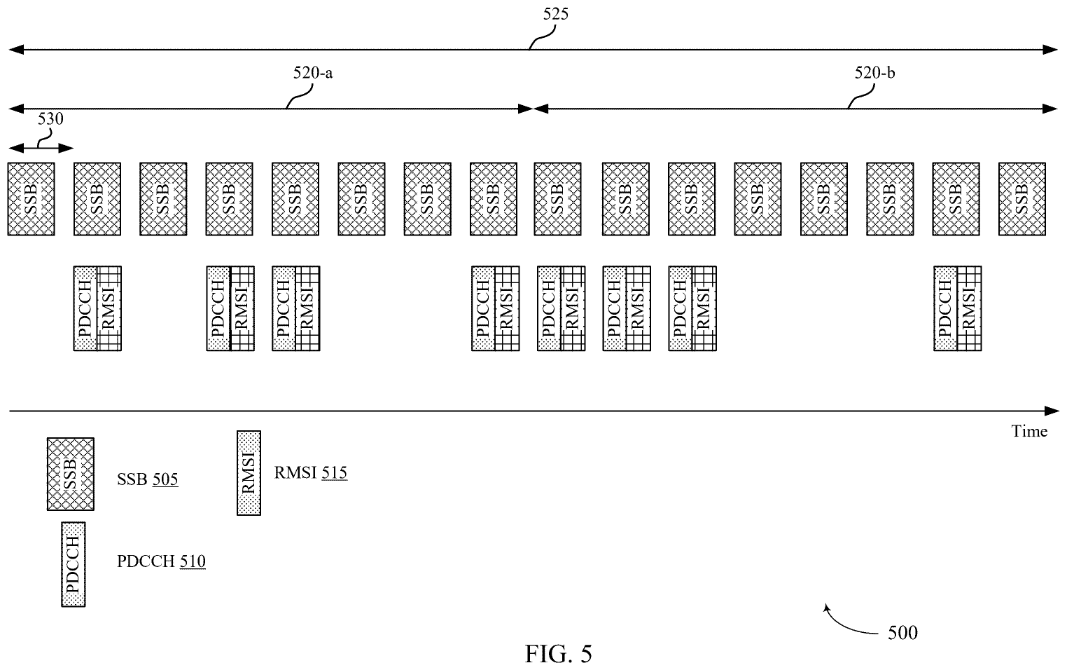

FIG. 5 shows an example of an SSB and RMSI periodicity diagram 500 that supports adaptive RMSI combining in accordance with one or more aspects of the present disclosure. The SSB and RMSI periodicity diagram 500 may implement or may be implemented by aspects of the wireless communications system 100 or the wireless communications system 400.

As described herein, a network entity 105 may transmit SSBs 505 in accordance with an SSB periodicity 530. For example, the SSB periodicity 530 may be 20 ms. The network entity 105 may transmit RMSI via RMSI PDSCH transmissions 515. The MIB in an SSB 505 may indicate a CORESET0 and search space set 0 (e.g., SSS0) to monitor for a PDCCH transmission 510, and the PDCCH transmission may include scheduling information for the corresponding RMSI PDSCH transmission. To save energy, the network entity 105 may not transmit a PDCCH transmission 510 and an RMSI PDSCH transmission 515 for each SSB 505. The UE 115 may assume that RMSI PDSCH transmissions 515 within a same RMSI period convey the same RMSI, and thus may be soft-combined.

In some examples, a control message such as a MIB may indicate the RMSI periodicity. For example, 1-bit in each MIB in each SSB 505 may indicate whether the RMSI periodicity is 160 ms or 320 ms. For example, if the RMSI periodicity is 160 ms, a first RMSI period 520-a and a second RMSI period 520-b may each be 160 ms. The UE 115 may combine RMSI from the RMSI PDSCH transmissions 515 received during the first RMSI period 520-a, and the UE 115 may combine RMSI from the RMSI PDSCH transmissions 515 received during the second RMSI period 520-b. If the RMSI periodicity is 320 ms, the RMSI period 525 may be 320 ms, and the UE 115 may combine RMSI from the RMSI PDSCH transmissions 515 received during the RMSI period 525. In some examples, the control message may include a 2-bit indication of the RMSI periodicity (e.g., to indicate one of 80 ms, 160 ms, 320 ms, or 640 ms). In some examples, the indication of the RMSI periodicity may be a function of the operating band or the SSB and RMSI multiplexing pattern. For example, the RMSI periodicity for FR2 may be indicated by the MIB (e.g., as one of 160 ms or 320 ms), while the RMSI periodicity may be fixed to 160 ms in FR1. As another example, the RMSI periodicity for multiplexing pattern two or three may be indicated by the MIB (e.g., as one of 160 ms or 320 ms), while the RMSI periodicity may be fixed to 160 ms for multiplexing pattern one. As another example, in FR2, one bit in the MIB may indicate between 160 ms and 640 ms, while in FR1 one bit in the MIB may indicate between 160 ms and 320 ms.

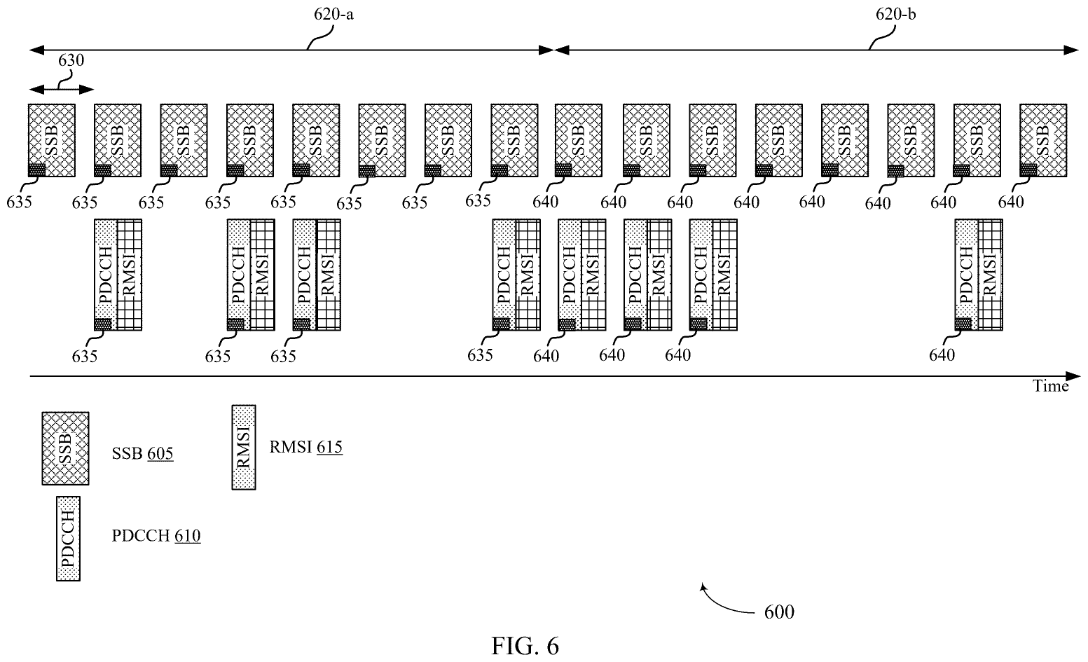

FIG. 6 shows an example of an SSB and RMSI periodicity diagram 600 that supports adaptive RMSI combining in accordance with one or more aspects of the present disclosure. The SSB and RMSI periodicity diagram 600 may implement or may be implemented by aspects of the wireless communications system 100 or the wireless communications system 400.

As described herein, a network entity 105 may transmit SSBs 605 in accordance with an SSB periodicity 630. For example, the SSB periodicity 630 may be 20 ms. The network entity 105 may transmit RMSI via RMSI PDSCH transmissions 615. The MIB in an SSB 605 may indicate a CORESET0 and search space set 0 (e.g., SSS0) to monitor for a PDCCH transmission 610, and the PDCCH transmission 610 may include scheduling information for the corresponding RMSI PDSCH transmission 615. To save energy, the network entity 105 may not transmit a PDCCH transmission 610 and an RMSI PDSCH transmission 615 for each SSB 605. The UE 115 may assume that RMSI PDSCH transmissions 615 within a same RMSI period 620 convey the same RMSI, and thus may be soft-combined. In some examples, RMSI periods 620 may be bundled. For example, RMSI PDSCH transmissions 615 within RMSI periods 620 that are bundled convey the same RMSI and thus may be soft-combined. The network entity 105 may dynamically indicate whether RMSI periods 620 are bundled.

In some examples, one bit in the PDCCH transmission 610 (e.g., one bit in the DCI conveyed by the PDCCH transmission 610) may indicate whether the current RMSI period is bundled with a subsequent RMSI period 620. For example, each PDCCH transmission 610 within the first RMSI period 620-a may include an indication 635 that the first RMSI period 620-a is bundled with the next consecutive RMSI period (e.g., the second RMSI period 620-b). As another example, one bit in the PDCCH transmission 610 (e.g., one bit in the DCI conveyed by the PDCCH transmission 610) may indicate whether the current RMSI period is bundled with a previous RMSI period 620. For example, each PDCCH transmission 610 within the second RMSI period 620-b may include an indication 640 that the second RMSI period 620-b is bundled with the previous RMSI period (e.g., the first RMSI period 620-a). In some examples, the one bit in the DCI in the PDCCH transmission 610 may be a new data indicator field (NDI) which indicates bundling based on toggling. For example, when toggled compared to the previous PDCCH transmission 610, the NDI field may indicate that the current RMSI period 620 is not bundled (e.g., that the RMSI payload has changed). In such examples, when not toggled compared to the previous PDCCH transmission 610, the NDI field may indicate that the current RMSI period 620 is bundled (e.g., that the RMSI payload has not changed and thus may be soft-combined).

In some examples, when there are multiple DCIs (e.g., multiple PDCCH transmissions 610 scheduling RMSI PDSCH transmissions 615) within a same RMSI period 620, the UE 115 may not expect to detect DCIs with inconsistent bundling information within the same RMSI period (e.g., all DCIs within a same RMSI period 620 may indicate the same bundling information). In some examples, when there are multiple DCIs within an RMSI period 620, the last detected DCI within the RMSI period 620 may indicate whether the RMSI period 620 is bundled with a subsequent consecutive RMSI period 620. In some examples, when there are multiple DCIs within an RMSI period 620, the first detected DCI within the RMSI period 620 may indicate whether the RMSI period 620 is bundled with a previous RMSI period 620.

In some examples, if no PDCCH transmission 610 that schedules an RMSI PDSCH transmission 615 is detected within a given RMSI period 620, the UE 115 may not soft combine RMSI PDSCHs across that RMSI period even if one bit in the DCI of a PDCCH transmission in a previous/subsequent RMSI period 620 indicates that the previous/subsequent RMSI period 620 is bundled with the given RMSI period as there are no RMSI PDSCHs in the given RMSI period to soft combine with the RMSI PDSCH transmissions from the previous/subsequent RMSI period 620. In some examples, if no PDCCH transmission 610 that schedules an RMSI PDSCH transmission 615 is detected within a given RMSI period 620 and toggling of NDI is used to indicate whether RMSI periods are bundled, the UE 115 may assume that NDI is toggled when no PDCCH transmission 610 that schedules an RMSI PDSCH transmission 615 is detected within a given RMSI period 620. For example, to assume an NDI is not toggled as compared to a previous PDCCH transmission 610, the previous PDCCH transmission 610 may be detected in the immediately previous RMSI period 620, otherwise the UE 115 may assume the NDI is toggled irrespective of the actual value of the NDI.

In some examples, the MIB in the SSB 605 may indicate whether a given RMSI period 620 is bundled with a previous/subsequent RMSI period 620. For example, each SSB 605 may include the indication 635 that the first RMSI period 620-a is bundled with the next consecutive RMSI period (e.g., the second RMSI period 620-b). In some examples, only the last SSB 605 within an RMSI period 620 may indicate whether the RMSI period 620 is bundled with the next consecutive RMSI period 620. In some examples, the MIB in the SSB 605 may include the indication 640 that the second RMSI period 620-b is bundled with the previous RMSI period (e.g., the first RMSI period 620-a). In some examples, only the first SSB 605 within an RMSI period 620 may indicate whether the RMSI period 620 is bundled with the immediately previous RMSI period 620.

In some examples, the indication of whether the RMSI period 620 is bundled with a previous/subsequent RMSI period 620 may be a function of the operating band or the SSB and RMSI multiplexing pattern. For example, the bundling indication may be used in FR2 but not in FR1. As another example, the bundling indication may be used for the multiplexing patterns two and three but not for the multiplexing pattern one.

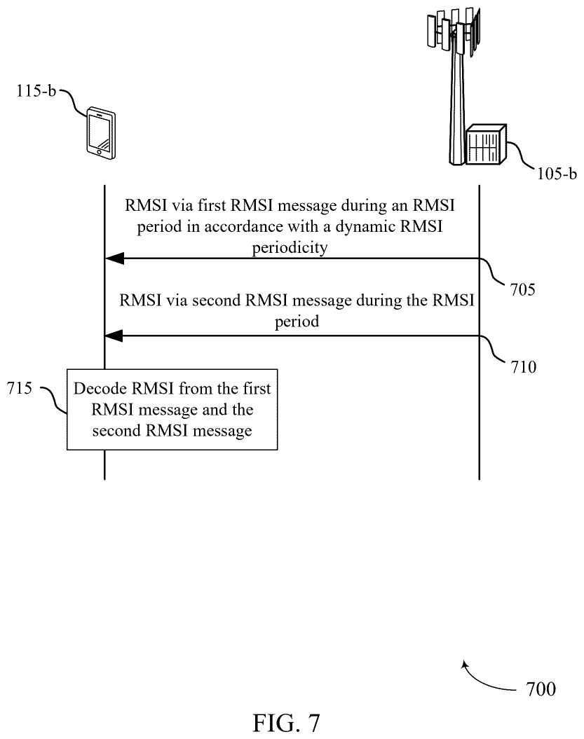

FIG. 7 shows an example of a process flow 700 that supports adaptive RMSI combining in accordance with one or more aspects of the present disclosure. The process flow 700 may include a UE 115-b and a network entity 105-b, which may be examples of a UE 115 and a network entity 105 as described herein. In the following description of the process flow 700, the communications between the network entity 105-b and the UE 115-b may be transmitted in a different order than the example order shown, or the operations performed by the network entity 105-b and the UE 115-b may be performed in different orders or at different times. Some operations may also be omitted from the process flow 700, and other operations may be added to the process flow 700.

At 705, the network entity 105-b may transmit, and the UE 115-b may receive, RMSI via a first RMSI message during an RMSI period in accordance with a dynamic RMSI periodicity. For example, the first RMSI message may be an RMSI PDSCH transmission as described herein.

At 710, the network entity 105-b may transmit, and the UE 115-b may receive, the RMSI via a second RMSI message during the RMSI period in accordance with the dynamic RMSI periodicity. For example, the second RMSI message may be an RMSI PDSCH transmission as described herein. The first RMSI message may have a same payload as the second RMSI message based on both of the first RMSI message and the second RMSI message being transmitted within the RMSI period in accordance with the dynamic RMSI periodicity.

At 715, the UE 115-b may decode the RMSI from the first RMSI message and the second RMSI message based on both of the first RMSI message and the second RMSI message being received within the dynamic RMSI periodicity.

In some examples, the network entity 105-b may transmit, and the UE 115-b may receive, a control message that indicates the dynamic RMSI periodicity from a set of candidate RMSI periodicities. In some examples, the control message may include a single bit field (e.g., a one bit field) that indicates the dynamic RMSI periodicity from two candidate RMSI periodicities. In some examples, the control message may include a two bit field that indicates the dynamic RMSI periodicity from four candidate RMSI periodicities. In some examples, the set of candidate RMSI periodicities may be based on an operating frequency band associated with the RMSI or a multiplexing pattern associated with SSBs (e.g., the multiplexing pattern one, two, or three as described with reference to FIG. 3). In some examples, the control message is a MIB in an SSB, the MIB indicates scheduling information for a PDCCH transmission, and the PDCCH transmission indicates scheduling information for the first RMSI message.

In some examples, the UE 115-b may determine the dynamic RMSI periodicity based on an operating frequency band associated with the RMSI or a multiplexing pattern associated with SSBs (e.g., the multiplexing pattern one, two, or three).

In some examples, the UE 115-b may perform a RACH procedure with a cell associated with the network entity 105-b based on decoding the RMSI.

In some examples, the dynamic RMSI periodicity is greater than 160 milliseconds.

In some examples, the UE 115-b decoding the RMSI may involve performing a soft combination of a first set of coded bits associated with the first RMSI message and a second set of coded bits associated with the second RMSI message.

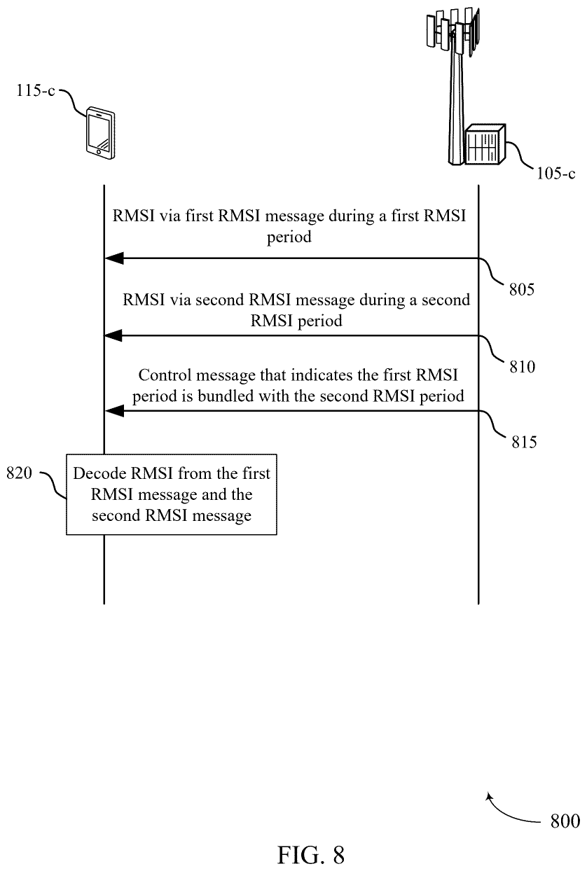

FIG. 8 shows an example of a process flow 800 that supports adaptive RMSI combining in accordance with one or more aspects of the present disclosure. The process flow 800 may include a UE 115-c and a network entity 105-c, which may be examples of a UE 115 and a network entity 105 as described herein. In the following description of the process flow 800, the communications between the network entity 105-c and the UE 115-c may be transmitted in a different order than the example order shown, or the operations performed by the network entity 105-c and the UE 115-c may be performed in different orders or at different times. Some operations may also be omitted from the process flow 800, and other operations may be added to the process flow 800.

At 805, the network entity 105-c may transmit, and the UE 115-c may receive, RMSI via a first RMSI message during a first RMSI period in accordance with an RMSI periodicity.

At 810, the network entity 105-c may transmit, and the UE 115-c may receive, the RMSI via a second RMSI message during a second RMSI period in accordance with the RMSI periodicity, where the second RMSI period is subsequent to and contiguous with the first RMSI period

At 815, the network entity 105-c may transmit, and the UE 115-c may receive, a control message that indicates that the first RMSI period is bundled with the second RMSI period. The first RMSI message may have a same payload as the second RMSI message based on the control message.

At 820, the UE 115-c may decode the RMSI from the first RMSI message and the second RMSI message based on the control message.

In some examples, the UE 115-c may receive the control message during the first RMSI period, and the control message may include a field that indicates that the first RMSI period is bundled with a subsequent and contiguous RMSI period. In some examples, the network entity 105-c may transmit, and the UE 115-c may receive, a set of multiple control messages during the first RMSI period, where the set of multiple control messages indicate respective scheduling information for a set of multiple respective RMSI messages during the first RMSI period, where the set of multiple respective RMSI messages includes the first RMSI message, and where the control message is a temporally last control message of the set of multiple control messages. In some examples, the control message may be one of DCI that that indicates scheduling information for the first RMSI message or a MIB.

In some examples, the UE 115-c may receive the control message during the second RMSI period, and the control message may include a field that indicates that the second RMSI period is bundled with a prior and contiguous RMSI period. In some examples, the network entity 105-c may transmit, and the UE 115-c may receive, a set of multiple control messages during the second RMSI period, where the set of multiple control messages indicate respective scheduling information for a set of multiple respective RMSI messages during the second RMSI period, where the set of multiple respective RMSI messages includes the second RMSI message, and where the control message is a temporally first control message of the set of multiple control messages. In some examples, the control message may be one of DCI that that indicates scheduling information for the first RMSI period or a MIB. In some examples, the control message the control message may be one of DCI that that indicates scheduling information for the first RMSI message or a MIB.

In some examples, the control message may be a second DCI that includes second scheduling information for the second RMSI message, and the NDI field in the second DCI indicates a same value as an NDI field in a first DCI that includes scheduling information for the first RMSI message. For example, bundling of RMSI periods may be indicated by not toggling NDI in DCI that schedules RMSI PDSCHs as described herein.

In some examples, the network entity 105-c may transmit, and the UE 115-c may receive, during one of the first RMSI period or the second RMSI period, a set of multiple control messages, where the set of multiple control messages include the control message, and where each of the set of multiple control messages indicates that the first RMSI period is bundled with the second RMSI period.

In some examples, decoding the RMSI from the first RMSI message and the second RMSI message is based on an operating frequency band associated with the RMSI or a multiplexing pattern associated with SSBs.

In some examples, the UE 115-c decoding the RMSI may involve performing a soft combination of a first set of coded bits associated with the first RMSI message and a second set of coded bits associated with the second RMSI message.

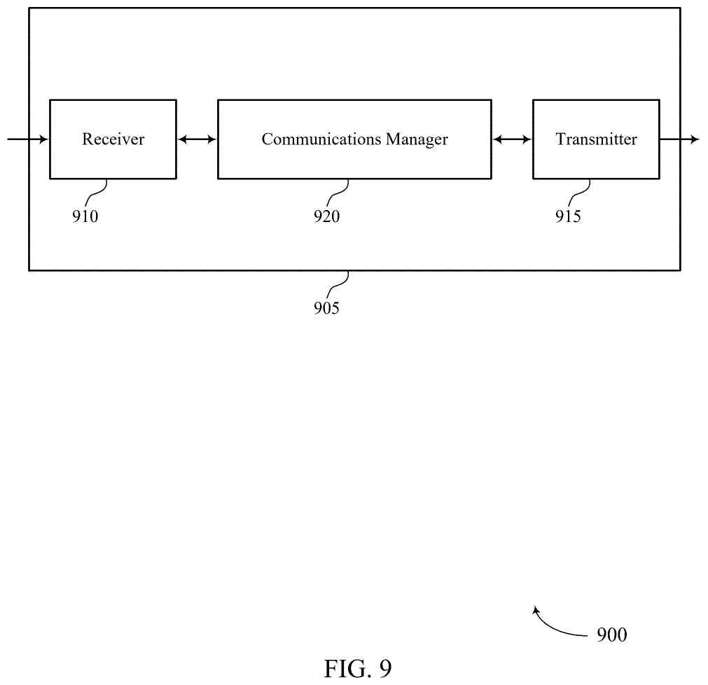

FIG. 9 shows a block diagram 900 of a device 905 that supports adaptive RMSI combining in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to adaptive RMSI combining). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to adaptive RMSI combining). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of adaptive RMSI combining as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving RMSI via a first RMSI message during an RMSI period in accordance with a dynamic RMSI periodicity. The communications manager 920 is capable of, configured to, or operable to support a means for receiving the RMSI via a second RMSI message during the RMSI period in accordance with the dynamic RMSI periodicity. The communications manager 920 is capable of, configured to, or operable to support a means for decoding the RMSI from the first RMSI message and the second RMSI message based on both of the first RMSI message and the second RMSI message being received within the dynamic RMSI periodicity.

Additionally, or alternatively, the communications manager 920 may support wireless communications in accordance with examples as disclosed herein. For example, the communications manager 920 is capable of, configured to, or operable to support a means for receiving RMSI via a first RMSI message during a first RMSI period in accordance with an RMSI periodicity. The communications manager 920 is capable of, configured to, or operable to support a means for receiving the RMSI via a second RMSI message during a second RMSI period in accordance with the RMSI periodicity, where the second RMSI period is subsequent to and contiguous with the first RMSI period. The communications manager 920 is capable of, configured to, or operable to support a means for receiving a control message that indicates that the first RMSI period is bundled with the second RMSI period. The communications manager 920 is capable of, configured to, or operable to support a means for decoding the RMSI from the first RMSI message and the second RMSI message based on the control message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing and more efficient utilization of communication resources.

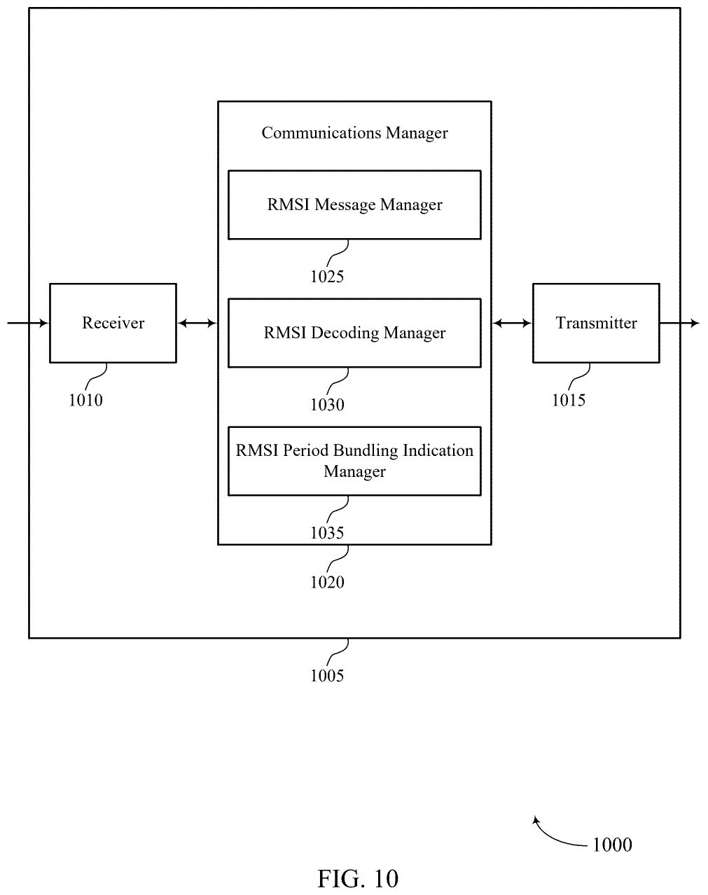

FIG. 10 shows a block diagram 1000 of a device 1005 that supports adaptive RMSI combining in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to adaptive RMSI combining). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to adaptive RMSI combining). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of adaptive RMSI combining as described herein. For example, the communications manager 1020 may include an RMSI message manager 1025, an RMSI decoding manager 1030, an RMSI period bundling indication manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The RMSI message manager 1025 is capable of, configured to, or operable to support a means for receiving RMSI via a first RMSI message during an RMSI period in accordance with a dynamic RMSI periodicity. The RMSI message manager 1025 is capable of, configured to, or operable to support a means for receiving the RMSI via a second RMSI message during the RMSI period in accordance with the dynamic RMSI periodicity. The RMSI decoding manager 1030 is capable of, configured to, or operable to support a means for decoding the RMSI from the first RMSI message and the second RMSI message based on both of the first RMSI message and the second RMSI message being received within the dynamic RMSI periodicity.

Additionally, or alternatively, the communications manager 1020 may support wireless communications in accordance with examples as disclosed herein. The RMSI message manager 1025 is capable of, configured to, or operable to support a means for receiving RMSI via a first RMSI message during a first RMSI period in accordance with an RMSI periodicity. The RMSI message manager 1025 is capable of, configured to, or operable to support a means for receiving the RMSI via a second RMSI message during a second RMSI period in accordance with the RMSI periodicity, where the second RMSI period is subsequent to and contiguous with the first RMSI period. The RMSI period bundling indication manager 1035 is capable of, configured to, or operable to support a means for receiving a control message that indicates that the first RMSI period is bundled with the second RMSI period. The RMSI decoding manager 1030 is capable of, configured to, or operable to support a means for decoding the RMSI from the first RMSI message and the second RMSI message based on the control message.

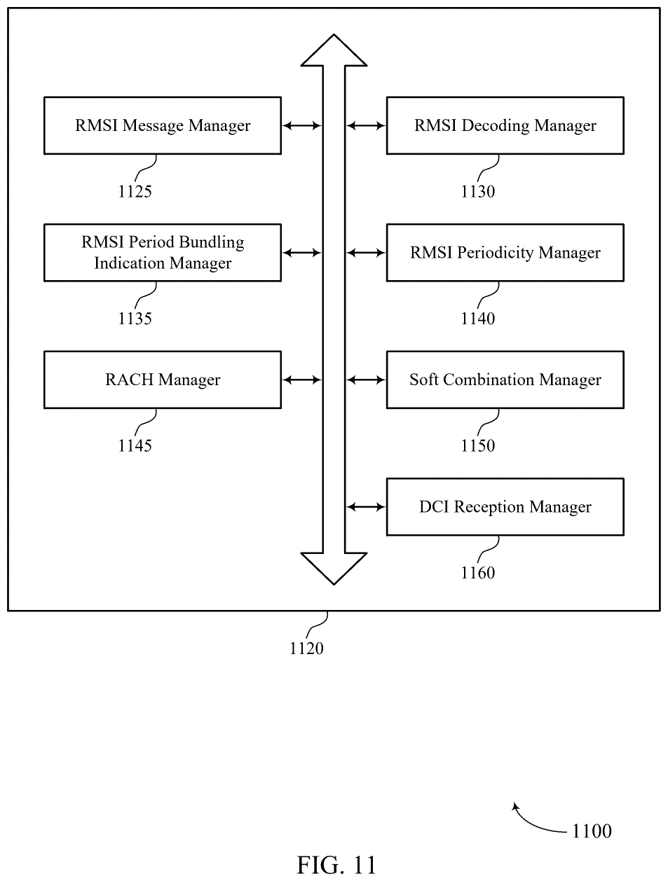

FIG. 11 shows a block diagram 1100 of a communications manager 1120 that supports adaptive RMSI combining in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of adaptive RMSI combining as described herein. For example, the communications manager 1120 may include an RMSI message manager 1125, an RMSI decoding manager 1130, an RMSI period bundling indication manager 1135, an RMSI periodicity manager 1140, a RACH manager 1145, a soft combination manager 1150, a DCI reception manager 1160, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The RMSI message manager 1125 is capable of, configured to, or operable to support a means for receiving RMSI via a first RMSI message during an RMSI period in accordance with a dynamic RMSI periodicity. In some examples, the RMSI message manager 1125 is capable of, configured to, or operable to support a means for receiving the RMSI via a second RMSI message during the RMSI period in accordance with the dynamic RMSI periodicity. The RMSI decoding manager 1130 is capable of, configured to, or operable to support a means for decoding the RMSI from the first RMSI message and the second RMSI message based on both of the first RMSI message and the second RMSI message being received within the dynamic RMSI periodicity.

In some examples, the RMSI periodicity manager 1140 is capable of, configured to, or operable to support a means for receiving a control message that indicates the dynamic RMSI periodicity from a set of candidate RMSI periodicities.

In some examples, to support receiving the control message, the RMSI periodicity manager 1140 is capable of, configured to, or operable to support a means for receiving the control message including a single bit field that indicates the dynamic RMSI periodicity from the set of candidate RMSI periodicities, the set of candidate RMSI periodicities including two candidate RMSI periodicities. In some examples, to support receiving the control message, the RMSI periodicity manager 1140 is capable of, configured to, or operable to support a means for receiving the control message including a two bit field that indicates the dynamic RMSI periodicity from the set of candidate RMSI periodicities, the set of candidate RMSI periodicities including four candidate RMSI periodicities.

In some examples, the set of candidate RMSI periodicities is based on an operating frequency band associated with the RMSI or a multiplexing pattern associated with SSBs.

In some examples, the control message is a MIB. In some examples, the MIB indicates first scheduling information for a physical downlink control channel transmission. In some examples, the physical downlink control channel transmission indicates second scheduling information for the first RMSI message.

In some examples, the RMSI periodicity manager 1140 is capable of, configured to, or operable to support a means for determining the dynamic RMSI periodicity based on an operating frequency band associated with the RMSI or a multiplexing pattern associated with SSBs.

In some examples, the RACH manager 1145 is capable of, configured to, or operable to support a means for performing, based on decoding the RMSI, a random access channel procedure with a cell, where the first RMSI message and the second RMSI message are both received from the cell.

In some examples, the dynamic RMSI periodicity is greater than 160 milliseconds.

In some examples, to support decoding the RMSI, the soft combination manager 1150 is capable of, configured to, or operable to support a means for performing a soft combination of a first set of coded bits associated with the first RMSI message and a second set of coded bits associated with the second RMSI message.

In some examples, the first RMSI message and the second RMSI message are associated with a same payload based on both of the first RMSI message and the second RMSI message being received within the dynamic RMSI periodicity.

Additionally, or alternatively, the communications manager 1120 may support wireless communications in accordance with examples as disclosed herein. In some examples, the RMSI message manager 1125 is capable of, configured to, or operable to support a means for receiving RMSI via a first RMSI message during a first RMSI period in accordance with an RMSI periodicity. In some examples, the RMSI message manager 1125 is capable of, configured to, or operable to support a means for receiving the RMSI via a second RMSI message during a second RMSI period in accordance with the RMSI periodicity, where the second RMSI period is subsequent to and contiguous with the first RMSI period. The RMSI period bundling indication manager 1135 is capable of, configured to, or operable to support a means for receiving a control message that indicates that the first RMSI period is bundled with the second RMSI period. In some examples, the RMSI decoding manager 1130 is capable of, configured to, or operable to support a means for decoding the RMSI from the first RMSI message and the second RMSI message based on the control message.

In some examples, to support receiving the control message, the RMSI period bundling indication manager 1135 is capable of, configured to, or operable to support a means for receiving the control message during the first RMSI period, where the control message includes a field that indicates that the first RMSI period is bundled with a subsequent and contiguous RMSI period.

In some examples, the RMSI period bundling indication manager 1135 is capable of, configured to, or operable to support a means for receiving a set of multiple control messages during the first RMSI period, where the set of multiple control messages indicate respective scheduling information for a set of multiple respective RMSI messages during the first RMSI period, where the set of multiple respective RMSI messages includes the first RMSI message, and where the control message is a temporally last control message of the set of multiple control messages.

In some examples, the control message includes one of DCI that indicates scheduling information for the first RMSI period or a MIB.

In some examples, to support receiving the control message, the RMSI period bundling indication manager 1135 is capable of, configured to, or operable to support a means for receiving the control message during the second RMSI period, where the control message includes a field that indicates that the second RMSI period is bundled with a prior and contiguous RMSI period.

In some examples, the RMSI period bundling indication manager 1135 is capable of, configured to, or operable to support a means for receiving a set of multiple control messages during the second RMSI period, where the set of multiple control messages indicate respective scheduling information for a set of multiple respective RMSI messages during the second RMSI period, where the set of multiple respective RMSI messages includes the first RMSI message, and where the control message is a temporally first control message of the set of multiple control messages.

In some examples, the control message includes one of DCI that indicates scheduling information for the second RMSI period or a MIB.

In some examples, to support receiving the control message, the DCI reception manager 1160 is capable of, configured to, or operable to support a means for receiving second DCI that includes second scheduling information for the second RMSI message, where a second new data indicator field of the second DCI indicates a same value as a first new data indicator field of first DCI that includes first scheduling information for the first RMSI message.

In some examples, the RMSI period bundling indication manager 1135 is capable of, configured to, or operable to support a means for receiving, during one of the first RMSI period or the second RMSI period, a set of multiple control messages, where the set of multiple control messages includes the control message, and where each of the set of multiple control messages indicates that the first RMSI period is bundled with the second RMSI period or each of the set of multiple control messages indicates that the first RMSI period is not bundled with the second RMSI period.

In some examples, decoding the RMSI from the first RMSI message and the second RMSI message is based on an operating frequency band associated with the RMSI or a multiplexing pattern associated with SSBs.

In some examples, the RACH manager 1145 is capable of, configured to, or operable to support a means for performing, based on decoding the RMSI, a random access channel procedure with a cell, where the first RMSI message and the second RMSI message are both received from the cell.

In some examples, to support decoding the RMSI, the soft combination manager 1150 is capable of, configured to, or operable to support a means for performing a soft combination of a first set of coded bits associated with the first RMSI message and a second set of coded bits associated with the second RMSI message.

In some examples, the first RMSI message and the second RMSI message are associated with a same payload based on the control message.

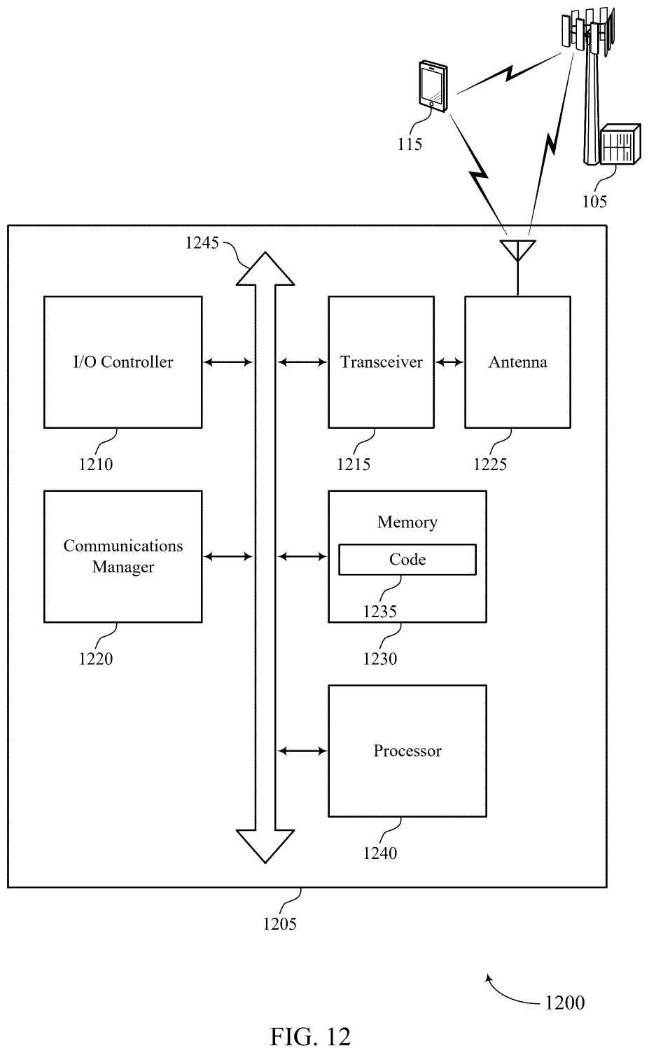

FIG. 12 shows a diagram of a system 1200 including a device 1205 that supports adaptive RMSI combining in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting adaptive RMSI combining). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving RMSI via a first RMSI message during an RMSI period in accordance with a dynamic RMSI periodicity. The communications manager 1220 is capable of, configured to, or operable to support a means for receiving the RMSI via a second RMSI message during the RMSI period in accordance with the dynamic RMSI periodicity. The communications manager 1220 is capable of, configured to, or operable to support a means for decoding the RMSI from the first RMSI message and the second RMSI message based on both of the first RMSI message and the second RMSI message being received within the dynamic RMSI periodicity.

Additionally, or alternatively, the communications manager 1220 may support wireless communications in accordance with examples as disclosed herein. For example, the communications manager 1220 is capable of, configured to, or operable to support a means for receiving RMSI via a first RMSI message during a first RMSI period in accordance with an RMSI periodicity. The communications manager 1220 is capable of, configured to, or operable to support a means for receiving the RMSI via a second RMSI message during a second RMSI period in accordance with the RMSI periodicity, where the second RMSI period is subsequent to and contiguous with the first RMSI period. The communications manager 1220 is capable of, configured to, or operable to support a means for receiving a control message that indicates that the first RMSI period is bundled with the second RMSI period. The communications manager 1220 is capable of, configured to, or operable to support a means for decoding the RMSI from the first RMSI message and the second RMSI message based on the control message.

By including or configuring the communications manager 1220 in accordance with examples as described herein, the device 1205 may support techniques for improved communication reliability, reduced latency, improved user experience related to reduced processing, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of adaptive RMSI combining as described herein, or the at least one processor 1240 and the at least one memory 1230 may be otherwise configured to, individually or collectively, perform or support such operations.

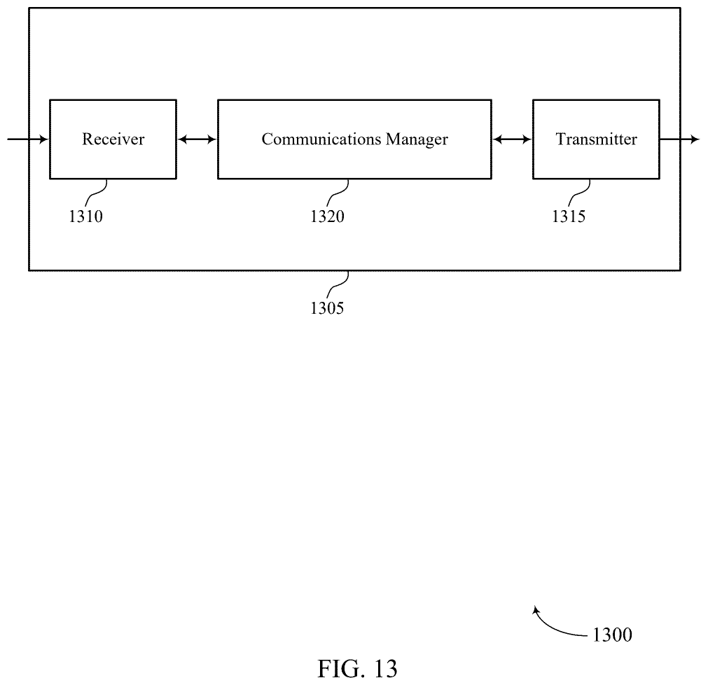

FIG. 13 shows a block diagram 1300 of a device 1305 that supports adaptive RMSI combining in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of adaptive RMSI combining as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for outputting, to a UE, an RMSI via a first RMSI message during an RMSI period in accordance with a dynamic RMSI periodicity. The communications manager 1320 is capable of, configured to, or operable to support a means for outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

Additionally, or alternatively, the communications manager 1320 may support wireless communications in accordance with examples as disclosed herein. For example, the communications manager 1320 is capable of, configured to, or operable to support a means for outputting, to a UE, an RMSI via a first RMSI message during a first RMSI period in accordance with an RMSI periodicity. The communications manager 1320 is capable of, configured to, or operable to support a means for outputting, to the UE, the RMSI via a second RMSI message during a second RMSI period in accordance with the RMSI periodicity, where the second RMSI period is subsequent to and contiguous with the first RMSI period. The communications manager 1320 is capable of, configured to, or operable to support a means for transmitting, to the UE, a control message that indicates that the first RMSI period is bundled with the second RMSI period, where the first RMSI message has a same payload as the second RMSI message based on the control message.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing and more efficient utilization of communication resources.

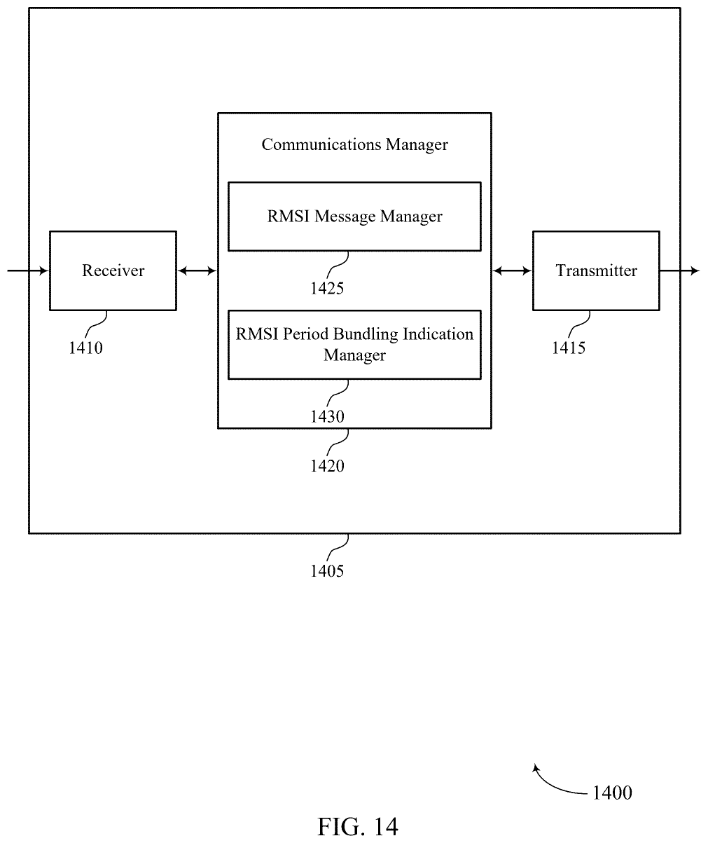

FIG. 14 shows a block diagram 1400 of a device 1405 that supports adaptive RMSI combining in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of adaptive RMSI combining as described herein. For example, the communications manager 1420 may include an RMSI message manager 1425 an RMSI period bundling indication manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The RMSI message manager 1425 is capable of, configured to, or operable to support a means for outputting, to a UE, an RMSI via a first RMSI message during an RMSI period in accordance with a dynamic RMSI periodicity. The RMSI message manager 1425 is capable of, configured to, or operable to support a means for outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

Additionally, or alternatively, the communications manager 1420 may support wireless communications in accordance with examples as disclosed herein. The RMSI message manager 1425 is capable of, configured to, or operable to support a means for outputting, to a UE, an RMSI via a first RMSI message during a first RMSI period in accordance with an RMSI periodicity. The RMSI message manager 1425 is capable of, configured to, or operable to support a means for outputting, to the UE, the RMSI via a second RMSI message during a second RMSI period in accordance with the RMSI periodicity, where the second RMSI period is subsequent to and contiguous with the first RMSI period. The RMSI period bundling indication manager 1430 is capable of, configured to, or operable to support a means for transmitting, to the UE, a control message that indicates that the first RMSI period is bundled with the second RMSI period, where the first RMSI message has a same payload as the second RMSI message based on the control message.

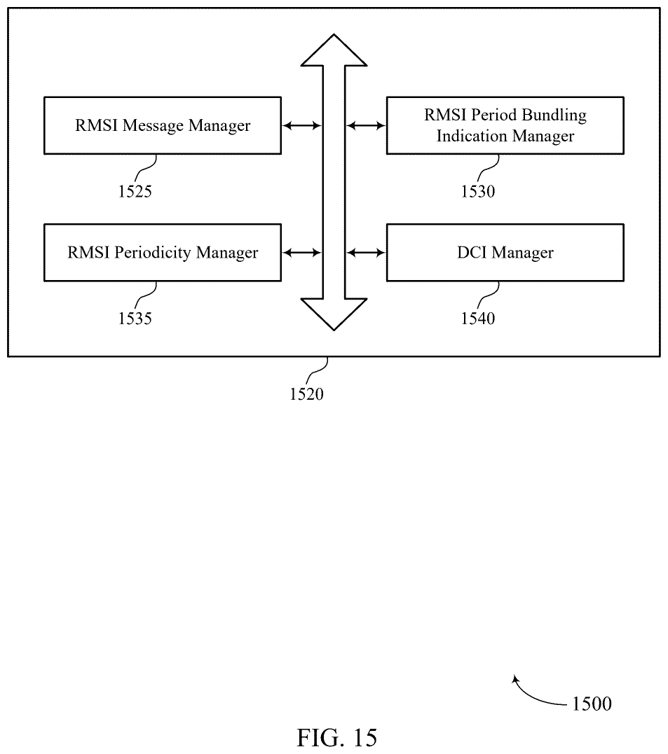

FIG. 15 shows a block diagram 1500 of a communications manager 1520 that supports adaptive RMSI combining in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of adaptive RMSI combining as described herein. For example, the communications manager 1520 may include an RMSI message manager 1525, an RMSI period bundling indication manager 1530, an RMSI periodicity manager 1535, a DCI manager 1540, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The RMSI message manager 1525 is capable of, configured to, or operable to support a means for outputting, to a UE, an RMSI via a first RMSI message during an RMSI period in accordance with a dynamic RMSI periodicity. In some examples, the RMSI message manager 1525 is capable of, configured to, or operable to support a means for outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

In some examples, the RMSI periodicity manager 1535 is capable of, configured to, or operable to support a means for outputting, to the UE, a control message that indicates the dynamic RMSI periodicity from a set of candidate RMSI periodicities.

In some examples, to support outputting the control message, the RMSI periodicity manager 1535 is capable of, configured to, or operable to support a means for outputting the control message including a single bit field that indicates the dynamic RMSI periodicity from the set of candidate RMSI periodicities, the set of candidate RMSI periodicities including two candidate RMSI periodicities. In some examples, to support outputting the control message, the RMSI periodicity manager 1535 is capable of, configured to, or operable to support a means for outputting the control message including a two bit field that indicates the dynamic RMSI periodicity from the set of candidate RMSI periodicities, the set of candidate RMSI periodicities including four candidate RMSI periodicities.

In some examples, the set of candidate RMSI periodicities is based on an operating frequency band associated with the RMSI or a multiplexing pattern associated with SSBs.

In some examples, the control message is a MIB. In some examples, the MIB indicates first scheduling information for a physical downlink control channel transmission, and. In some examples, the physical downlink control channel transmission indicates second scheduling information for the first RMSI message.

In some examples, the dynamic RMSI periodicity is based on an operating frequency band associated with the RMSI or a multiplexing pattern associated with SSBs.

In some examples, the dynamic RMSI periodicity is greater than 160 milliseconds.

Additionally, or alternatively, the communications manager 1520 may support wireless communications in accordance with examples as disclosed herein. In some examples, the RMSI message manager 1525 is capable of, configured to, or operable to support a means for outputting, to a UE, an RMSI via a first RMSI message during a first RMSI period in accordance with an RMSI periodicity. In some examples, the RMSI message manager 1525 is capable of, configured to, or operable to support a means for outputting, to the UE, the RMSI via a second RMSI message during a second RMSI period in accordance with the RMSI periodicity, where the second RMSI period is subsequent to and contiguous with the first RMSI period. The RMSI period bundling indication manager 1530 is capable of, configured to, or operable to support a means for transmitting, to the UE, a control message that indicates that the first RMSI period is bundled with the second RMSI period, where the first RMSI message has a same payload as the second RMSI message based on the control message.

In some examples, to support outputting the control message, the RMSI period bundling indication manager 1530 is capable of, configured to, or operable to support a means for outputting the control message during the first RMSI period, where the control message includes a field that indicates that the first RMSI period is bundled with a subsequent and contiguous RMSI period.

In some examples, the RMSI period bundling indication manager 1530 is capable of, configured to, or operable to support a means for outputting a set of multiple control messages during the first RMSI period, where the set of multiple control messages indicate respective scheduling information for a set of multiple respective RMSI messages during the first RMSI period, where the set of multiple respective RMSI messages includes the first RMSI message, and where the control message is a temporally last control message of the set of multiple control messages.

In some examples, the control message includes one of DCI that indicates scheduling information for the first RMSI period or a MIB.

In some examples, to support outputting the control message, the RMSI period bundling indication manager 1530 is capable of, configured to, or operable to support a means for outputting the control message during the second RMSI period, where the control message includes a field that indicates that the second RMSI period is bundled with a prior and contiguous RMSI period.

In some examples, the RMSI period bundling indication manager 1530 is capable of, configured to, or operable to support a means for outputting a set of multiple control messages during the second RMSI period, where the set of multiple control messages indicate respective scheduling information for a set of multiple respective RMSI messages during the second RMSI period, where the set of multiple respective RMSI messages includes the first RMSI message, and where the control message is a temporally first control message of the set of multiple control messages.

In some examples, the control message includes one of DCI that indicates scheduling information for the second RMSI period or a MIB.

In some examples, the RMSI period bundling indication manager 1530 is capable of, configured to, or operable to support a means for outputting, during one of the first RMSI period or the second RMSI period, a set of multiple control messages, where the set of multiple control messages includes the control message, and where each of the set of multiple control messages indicates that the first RMSI period is bundled with the second RMSI period or each of the set of multiple control messages indicates that the first RMSI period is not bundled with the second RMSI period.

In some examples, to support outputting the control message, the DCI manager 1540 is capable of, configured to, or operable to support a means for outputting second DCI that includes second scheduling information for the second RMSI message, where a second new data indicator field of the second DCI indicates a same value as a first new data indicator field of first DCI that includes first scheduling information for the first RMSI message.

In some examples, the first RMSI message having the same payload as the second RMSI message is based on an operating frequency band associated with the RMSI or a multiplexing pattern associated with SSBs.

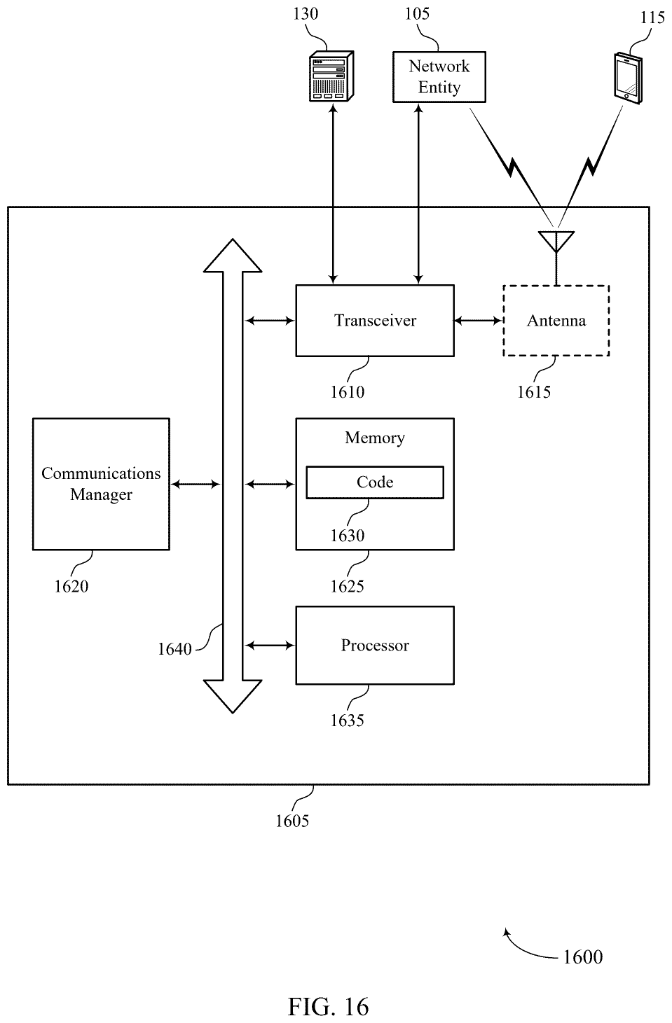

FIG. 16 shows a diagram of a system 1600 including a device 1605 that supports adaptive RMSI combining in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting adaptive RMSI combining). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for outputting, to a UE, an RMSI via a first RMSI message during an RMSI period in accordance with a dynamic RMSI periodicity. The communications manager 1620 is capable of, configured to, or operable to support a means for outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity.

Additionally, or alternatively, the communications manager 1620 may support wireless communications in accordance with examples as disclosed herein. For example, the communications manager 1620 is capable of, configured to, or operable to support a means for outputting, to a UE, an RMSI via a first RMSI message during a first RMSI period in accordance with an RMSI periodicity. The communications manager 1620 is capable of, configured to, or operable to support a means for outputting, to the UE, the RMSI via a second RMSI message during a second RMSI period in accordance with the RMSI periodicity, where the second RMSI period is subsequent to and contiguous with the first RMSI period. The communications manager 1620 is capable of, configured to, or operable to support a means for transmitting, to the UE, a control message that indicates that the first RMSI period is bundled with the second RMSI period, where the first RMSI message has a same payload as the second RMSI message based on the control message.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of adaptive RMSI combining as described herein, or the at least one processor 1635 and the at least one memory 1625 may be otherwise configured to, individually or collectively, perform or support such operations.

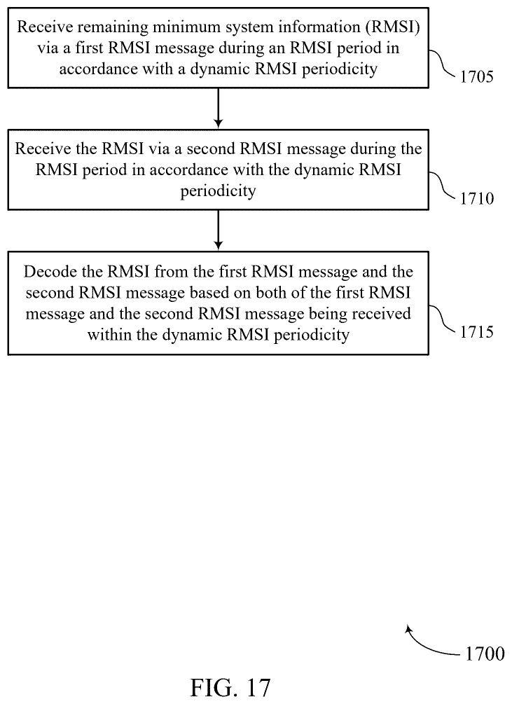

FIG. 17 shows a flowchart illustrating a method 1700 that supports adaptive RMSI combining in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving RMSI via a first RMSI message during an RMSI period in accordance with a dynamic RMSI periodicity. The operations of 1705 may be performed in accordance with examples as disclosed herein. In some examples, aspects of the operations of 1705 may be performed by an RMSI message manager 1125 as described with reference to FIG. 11.

At 1710, the method may include receiving the RMSI via a second RMSI message during the RMSI period in accordance with the dynamic RMSI periodicity. The operations of 1710 may be performed in accordance with examples as disclosed herein. In some examples, aspects of the operations of 1710 may be performed by an RMSI message manager 1125 as described with reference to FIG. 11.

At 1715, the method may include decoding the RMSI from the first RMSI message and the second RMSI message based on both of the first RMSI message and the second RMSI message being received within the dynamic RMSI periodicity. The operations of 1715 may be performed in accordance with examples as disclosed herein. In some examples, aspects of the operations of 1715 may be performed by an RMSI decoding manager 1130 as described with reference to FIG. 11.

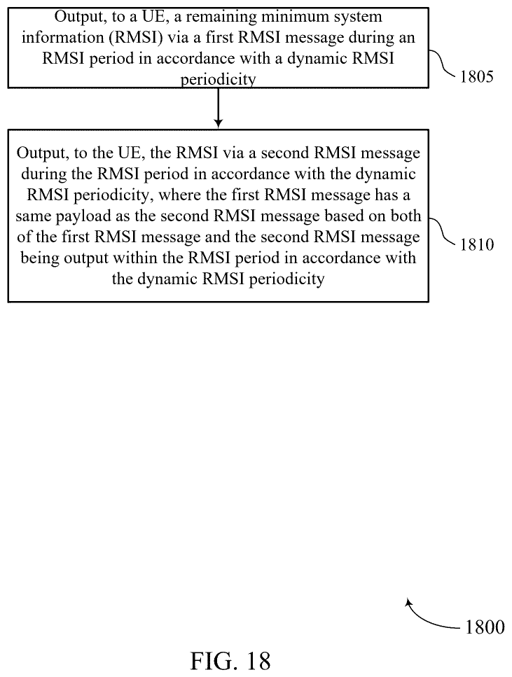

FIG. 18 shows a flowchart illustrating a method 1800 that supports adaptive RMSI combining in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a UE, an RMSI via a first RMSI message during an RMSI period in accordance with a dynamic RMSI periodicity. The operations of 1805 may be performed in accordance with examples as disclosed herein. In some examples, aspects of the operations of 1805 may be performed by an RMSI message manager 1525 as described with reference to FIG. 15.

At 1810, the method may include outputting, to the UE, the RMSI via a second RMSI message during the RMSI period in accordance with the dynamic RMSI periodicity, where the first RMSI message has a same payload as the second RMSI message based on both of the first RMSI message and the second RMSI message being output within the RMSI period in accordance with the dynamic RMSI periodicity. The operations of 1810 may be performed in accordance with examples as disclosed herein. In some examples, aspects of the operations of 1810 may be performed by an RMSI message manager 1525 as described with reference to FIG. 15.

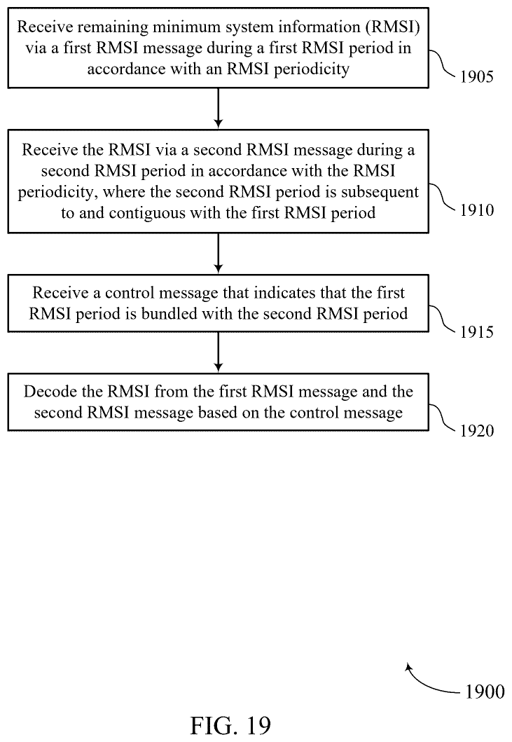

FIG. 19 shows a flowchart illustrating a method 1900 that supports adaptive RMSI combining in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving RMSI via a first RMSI message during a first RMSI period in accordance with an RMSI periodicity. The operations of 1905 may be performed in accordance with examples as disclosed herein. In some examples, aspects of the operations of 1905 may be performed by an RMSI message manager 1125 as described with reference to FIG. 11.

At 1910, the method may include receiving the RMSI via a second RMSI message during a second RMSI period in accordance with the RMSI periodicity, where the second RMSI period is subsequent to and contiguous with the first RMSI period. The operations of 1910 may be performed in accordance with examples as disclosed herein. In some examples, aspects of the operations of 1910 may be performed by an RMSI message manager 1125 as described with reference to FIG. 11.

At 1915, the method may include receiving a control message that indicates that the first RMSI period is bundled with the second RMSI period. The operations of 1915 may be performed in accordance with examples as disclosed herein. In some examples, aspects of the operations of 1915 may be performed by an RMSI period bundling indication manager 1135 as described with reference to FIG. 11.

At 1920, the method may include decoding the RMSI from the first RMSI message and the second RMSI message based on the control message. The operations of 1920 may be performed in accordance with examples as disclosed herein. In some examples, aspects of the operations of 1920 may be performed by an RMSI decoding manager 1130 as described with reference to FIG. 11.

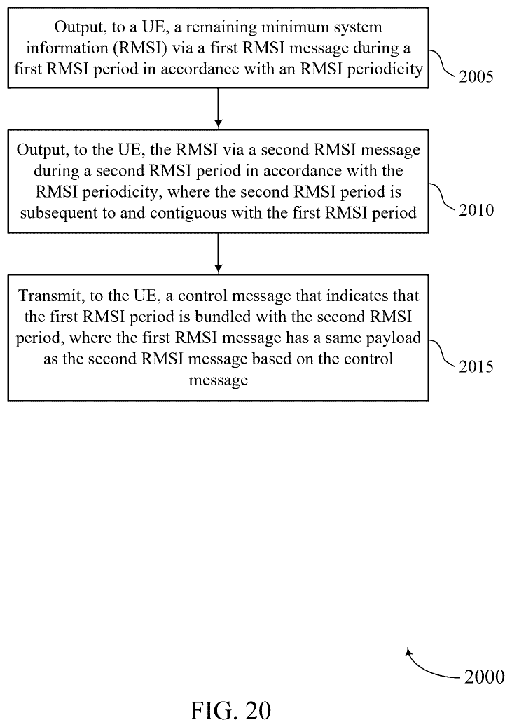

FIG. 20 shows a flowchart illustrating a method 2000 that supports adaptive RMSI combining in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting, to a UE, an RMSI via a first RMSI message during a first RMSI period in accordance with an RMSI periodicity. The operations of 2005 may be performed in accordance with examples as disclosed herein. In some examples, aspects of the operations of 2005 may be performed by an RMSI message manager 1525 as described with reference to FIG. 15.

At 2010, the method may include outputting, to the UE, the RMSI via a second RMSI message during a second RMSI period in accordance with the RMSI periodicity, where the second RMSI period is subsequent to and contiguous with the first RMSI period. The operations of 2010 may be performed in accordance with examples as disclosed herein. In some examples, aspects of the operations of 2010 may be performed by an RMSI message manager 1525 as described with reference to FIG. 15.

At 2015, the method may include transmitting, to the UE, a control message that indicates that the first RMSI period is bundled with the second RMSI period, where the first RMSI message has a same payload as the second RMSI message based on the control message. The operations of 2015 may be performed in accordance with examples as disclosed herein. In some examples, aspects of the operations of 2015 may be performed by an RMSI period bundling indication manager 1530 as described with reference to FIG. 15.

The following provides an overview of aspects of the present disclosure:

Aspect 1: A method for wireless communications at a UE, comprising: receiving RMSI via a first RMSI message during an RMSI period in accordance with a dynamic RMSI periodicity; receiving the RMSI via a second RMSI message during the RMSI period in accordance with the dynamic RMSI periodicity; and decoding the RMSI from the first RMSI message and the second RMSI message based at least in part on both of the first RMSI message and the second RMSI message being received within the dynamic RMSI periodicity.

Aspect 2: The method of aspect 1, further comprising: receiving a control message that indicates the dynamic RMSI periodicity from a set of candidate RMSI periodicities.

Aspect 3: The method of aspect 2, wherein receiving the control message comprises: receiving the control message comprising a single bit field that indicates the dynamic RMSI periodicity from the set of candidate RMSI periodicities, the set of candidate RMSI periodicities comprising two candidate RMSI periodicities; or receiving the control message comprising a two bit field that indicates the dynamic RMSI periodicity from the set of candidate RMSI periodicities, the set of candidate RMSI periodicities comprising four candidate RMSI periodicities.

Aspect 4: The method of any of aspects 2 through 3, wherein the set of candidate RMSI periodicities is based at least in part on an operating frequency band associated with the RMSI or a multiplexing pattern associated with SSBs.

Aspect 5: The method of any of aspects 2 through 4, wherein the control message is a MIB, the MIB indicates first scheduling information for a physical downlink control channel transmission, and the physical downlink control channel transmission indicates second scheduling information for the first RMSI message.

Aspect 6: The method of any of aspects 1 through 5, further comprising: determining the dynamic RMSI periodicity based at least in part on an operating frequency band associated with the RMSI or a multiplexing pattern associated with SSBs.

Aspect 7: The method of any of aspects 1 through 6, further comprising: performing, based at least in part on decoding the RMSI, a RACH procedure with a cell, wherein the first RMSI message and the second RMSI message are both received from the cell.

Aspect 8: The method of any of aspects 1 through 7, wherein the dynamic RMSI periodicity is greater than 160 milliseconds.

Aspect 9: The method of any of aspects 1 through 8, wherein decoding the RMSI comprises: performing a soft combination of a first set of coded bits associated with the first RMSI message and a second set of coded bits associated with the second RMSI message.

Aspect 10: The method of any of aspects 1 through 9, wherein the first RMSI message and the second RMSI message are associated with a same payload based at least in part on both of the first RMSI message and the second RMSI message being received within the dynamic RMSI periodicity.

Aspect 11: A method for wireless communications at a network entity, comprising: outputting, to a UE, an RMSI via a first RMSI message during an RMSI period in accordance with a dynamic RMSI periodicity; and outputting, to the UE, the RMSI via a second RMSI message during the RMSI period in accordance with the dynamic RMSI periodicity, wherein the first RMSI message has a same payload as the second RMSI message based at least in part on both of the first RMSI message and the second RMSI message being output within the RMSI period in accordance with the dynamic RMSI periodicity.

Aspect 12: The method of aspect 11, further comprising: outputting, to the UE, a control message that indicates the dynamic RMSI periodicity from a set of candidate RMSI periodicities.

Aspect 13: The method of aspect 12, wherein outputting the control message comprises: outputting the control message comprising a single bit field that indicates the dynamic RMSI periodicity from the set of candidate RMSI periodicities, the set of candidate RMSI periodicities comprising two candidate RMSI periodicities; or outputting the control message comprising a two bit field that indicates the dynamic RMSI periodicity from the set of candidate RMSI periodicities, the set of candidate RMSI periodicities comprising four candidate RMSI periodicities.

Aspect 14: The method of any of aspects 12 through 13, wherein the set of candidate RMSI periodicities is based at least in part on an operating frequency band associated with the RMSI or a multiplexing pattern associated with SSBs.

Aspect 15: The method of any of aspects 12 through 14, wherein the control message is a MIB, the MIB indicates first scheduling information for a physical downlink control channel transmission, and, and the physical downlink control channel transmission indicates second scheduling information for the first RMSI message.

Aspect 16: The method of any of aspects 11 through 15, wherein the dynamic RMSI periodicity is based at least in part on an operating frequency band associated with the RMSI or a multiplexing pattern associated with SSBs.

Aspect 17: The method of any of aspects 11 through 16, wherein the dynamic RMSI periodicity is greater than 160 milliseconds.

Aspect 18: A method for wireless communications at a UE, comprising: receiving RMSI via a first RMSI message during a first RMSI period in accordance with an RMSI periodicity; receiving the RMSI via a second RMSI message during a second RMSI period in accordance with the RMSI periodicity, wherein the second RMSI period is subsequent to and contiguous with the first RMSI period; receiving a control message that indicates that the first RMSI period is bundled with the second RMSI period; and decoding the RMSI from the first RMSI message and the second RMSI message based at least in part on the control message.

Aspect 19: The method of aspect 18, wherein receiving the control message comprises: receiving the control message during the first RMSI period, wherein the control message comprises a field that indicates that the first RMSI period is bundled with a subsequent and contiguous RMSI period.

Aspect 20: The method of aspect 19, further comprising: receiving a plurality of control messages during the first RMSI period, wherein the plurality of control messages indicate respective scheduling information for a plurality of respective RMSI messages during the first RMSI period, wherein the plurality of respective RMSI messages comprises the first RMSI message, and wherein the control message is a temporally last control message of the plurality of control messages.

Aspect 21: The method of any of aspects 19 through 20, wherein the control message comprises one of DCI that indicates scheduling information for the first RMSI period or a MIB.

Aspect 22: The method of aspect 18, wherein receiving the control message comprises: receiving the control message during the second RMSI period, wherein the control message comprises a field that indicates that the second RMSI period is bundled with a prior and contiguous RMSI period.

Aspect 23: The method of aspect 22, further comprising: receiving a plurality of control messages during the second RMSI period, wherein the plurality of control messages indicate respective scheduling information for a plurality of respective RMSI messages during the second RMSI period, wherein the plurality of respective RMSI messages comprises the first RMSI message, and wherein the control message is a temporally first control message of the plurality of control messages.

Aspect 24: The method of any of aspects 22 through 23, wherein the control message comprises one of DCI that indicates scheduling information for the second RMSI period or a MIB.

Aspect 25: The method of any of aspects 18 through 24, wherein receiving the control message comprises: receiving second DCI that includes second scheduling information for the second RMSI message, wherein a second NDI field of the second DCI indicates a same value as a first NDI field of first DCI that includes first scheduling information for the first RMSI message.

Aspect 26: The method of any of aspects 18 through 25, further comprising: receiving, during one of the first RMSI period or the second RMSI period, a plurality of control messages, wherein the plurality of control messages comprises the control message, and wherein each of the plurality of control messages indicates that the first RMSI period is bundled with the second RMSI period or each of the plurality of control messages indicates that the first RMSI period is not bundled with the second RMSI period.

Aspect 27: The method of any of aspects 18 through 26, wherein decoding the RMSI from the first RMSI message and the second RMSI message is based at least in part on an operating frequency band associated with the RMSI or a multiplexing pattern associated with SSBs.

Aspect 28: The method of any of aspects 18 through 27, further comprising: performing, based at least in part on decoding the RMSI, a RACH procedure with a cell, wherein the first RMSI message and the second RMSI message are both received from the cell.

Aspect 29: The method of any of aspects 18 through 28, wherein decoding the RMSI comprises: performing a soft combination of a first set of coded bits associated with the first RMSI message and a second set of coded bits associated with the second RMSI message.

Aspect 30: The method of any of aspects 18 through 29, wherein the first RMSI message and the second RMSI message are associated with a same payload based at least in part on the control message.

Aspect 31: A method for wireless communications at a network entity, comprising: outputting, to a UE, an RMSI via a first RMSI message during a first RMSI period in accordance with an RMSI periodicity; outputting, to the UE, the RMSI via a second RMSI message during a second RMSI period in accordance with the RMSI periodicity, wherein the second RMSI period is subsequent to and contiguous with the first RMSI period; and transmitting, to the UE, a control message that indicates that the first RMSI period is bundled with the second RMSI period, wherein the first RMSI message has a same payload as the second RMSI message based at least in part on the control message.

Aspect 32: The method of aspect 31, wherein outputting the control message comprises: outputting the control message during the first RMSI period, wherein the control message comprises a field that indicates that the first RMSI period is bundled with a subsequent and contiguous RMSI period.

Aspect 33: The method of aspect 32, further comprising: outputting a plurality of control messages during the first RMSI period, wherein the plurality of control messages indicate respective scheduling information for a plurality of respective RMSI messages during the first RMSI period, wherein the plurality of respective RMSI messages comprises the first RMSI message, and wherein the control message is a temporally last control message of the plurality of control messages.

Aspect 34: The method of any of aspects 32 through 33, wherein the control message comprises one of DCI that indicates scheduling information for the first RMSI period or a MIB.

Aspect 35: The method of aspect 31, wherein outputting the control message comprises: outputting the control message during the second RMSI period, wherein the control message comprises a field that indicates that the second RMSI period is bundled with a prior and contiguous RMSI period.

Aspect 36: The method of aspect 35, further comprising: outputting a plurality of control messages during the second RMSI period, wherein the plurality of control messages indicate respective scheduling information for a plurality of respective RMSI messages during the second RMSI period, wherein the plurality of respective RMSI messages comprises the first RMSI message, and wherein the control message is a temporally first control message of the plurality of control messages.

Aspect 37: The method of any of aspects 35 through 36, wherein the control message comprises one of DCI that indicates scheduling information for the second RMSI period or a MIB.

Aspect 38: The method of any of aspects 35 through 37, further comprising: outputting, during one of the first RMSI period or the second RMSI period, a plurality of control messages, wherein the plurality of control messages comprises the control message, and wherein each of the plurality of control messages indicates that the first RMSI period is bundled with the second RMSI period or each of the plurality of control messages indicates that the first RMSI period is not bundled with the second RMSI period.

Aspect 39: The method of any of aspects 31 through 38, wherein outputting the control message comprises: outputting second DCI that includes second scheduling information for the second RMSI message, wherein a second NDI field of the second DCI indicates a same value as a first NDI field of first DCI that includes first scheduling information for the first RMSI message.

Aspect 40: The method of any of aspects 31 through 39, wherein the first RMSI message having the same payload as the second RMSI message is based at least in part on an operating frequency band associated with the RMSI or a multiplexing pattern associated with SSBs.

Aspect 41: A UE for wireless communications, comprising one or more memories storing processor-executable code, and one or more processors coupled with the one or more memories and individually or collectively operable to execute the code to cause the UE to perform a method of any of aspects 1 through 10.

Aspect 42: A UE for wireless communications, comprising at least one means for performing a method of any of aspects 1 through 10.

Aspect 43: A non-transitory computer-readable medium storing code for wireless communications, the code comprising instructions executable by one or more processors to perform a method of any of aspects 1 through 10.

Aspect 44: A network entity for wireless communications, comprising one or more memories storing processor-executable code, and one or more processors coupled with the one or more memories and individually or collectively operable to execute the code to cause the network entity to perform a method of any of aspects 11 through 17.

Aspect 45: A network entity for wireless communications, comprising at least one means for performing a method of any of aspects 11 through 17.

Aspect 46: A non-transitory computer-readable medium storing code for wireless communications, the code comprising instructions executable by one or more processors to perform a method of any of aspects 11 through 17.

Aspect 47: A UE for wireless communications, comprising one or more memories storing processor-executable code, and one or more processors coupled with the one or more memories and individually or collectively operable to execute the code to cause the UE to perform a method of any of aspects 18 through 30.

Aspect 48: A UE for wireless communications, comprising at least one means for performing a method of any of aspects 18 through 30.

Aspect 49: A non-transitory computer-readable medium storing code for wireless communications, the code comprising instructions executable by one or more processors to perform a method of any of aspects 18 through 30.

Aspect 50: A network entity for wireless communications, comprising one or more memories storing processor-executable code, and one or more processors coupled with the one or more memories and individually or collectively operable to execute the code to cause the network entity to perform a method of any of aspects 31 through 40.

Aspect 51: A network entity for wireless communications, comprising at least one means for performing a method of any of aspects 31 through 40.

Aspect 52: A non-transitory computer-readable medium storing code for wireless communications, the code comprising instructions executable by one or more processors to perform a method of any of aspects 31 through 40.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive remaining minimum system information (RMSI) via a first RMSI message during an RMSI period in accordance with a dynamic RMSI periodicity;
receive the RMSI via a second RMSI message during the RMSI period in accordance with the dynamic RMSI periodicity; and
decode the RMSI from the first RMSI message and the second RMSI message based at least in part on both of the first RMSI message and the second RMSI message being received within the dynamic RMSI periodicity.

2. The UE of claim 1, wherein the one or more processors are individually or collectively further operable to execute the code to cause the UE to:
receive a control message that indicates the dynamic RMSI periodicity from a set of candidate RMSI periodicities.

3. The UE of claim 2, wherein, to receive the control message, the one or more processors are individually or collectively operable to execute the code to cause the UE to:
receive the control message comprising a single bit field that indicates the dynamic RMSI periodicity from the set of candidate RMSI periodicities, the set of candidate RMSI periodicities comprising two candidate RMSI periodicities; or
receive the control message comprising a two bit field that indicates the dynamic RMSI periodicity from the set of candidate RMSI periodicities, the set of candidate RMSI periodicities comprising four candidate RMSI periodicities.

4. The UE of claim 2, wherein the set of candidate RMSI periodicities is based at least in part on an operating frequency band associated with the RMSI or a multiplexing pattern associated with synchronization signal blocks.

5. The UE of claim 2, wherein:
the control message is a master information block,
the master information block indicates first scheduling information for a physical downlink control channel transmission, and
the physical downlink control channel transmission indicates second scheduling information for the first RMSI message.

6. The UE of claim 1, wherein the one or more processors are individually or collectively further operable to execute the code to cause the UE to:
determine the dynamic RMSI periodicity based at least in part on an operating frequency band associated with the RMSI or a multiplexing pattern associated with synchronization signal blocks.

7. The UE of claim 1, wherein, to decode the RMSI, the one or more processors are individually or collectively operable to execute the code to cause the UE to:
perform a soft combination of a first set of coded bits associated with the first RMSI message and a second set of coded bits associated with the second RMSI message.

8. The UE of claim 1, wherein the first RMSI message and the second RMSI message are associated with a same payload based at least in part on both of the first RMSI message and the second RMSI message being received within the dynamic RMSI periodicity.

9. A network entity, comprising:
one or more memories storing processor-executable code; and
one or more processors coupled with the one or more memories and individually or collectively operable to execute the code to cause the network entity to:
output, to a user equipment (UE), a remaining minimum system information (RMSI) via a first RMSI message during an RMSI period in accordance with a dynamic RMSI periodicity; and
output, to the UE, the RMSI via a second RMSI message during the RMSI period in accordance with the dynamic RMSI periodicity, wherein the first RMSI message has a same payload as the second RMSI message based at least in part on both of the first RMSI message and the second RMSI message being output within the RMSI period in accordance with the dynamic RMSI periodicity.

10. The network entity of claim 9, wherein the one or more processors are individually or collectively further operable to execute the code to cause the network entity to:
output, to the UE, a control message that indicates the dynamic RMSI periodicity from a set of candidate RMSI periodicities.

11. The network entity of claim 10, wherein, to output the control message, the one or more processors are individually or collectively operable to execute the code to cause the network entity to:
output the control message comprising a single bit field that indicates the dynamic RMSI periodicity from the set of candidate RMSI periodicities, the set of candidate RMSI periodicities comprising two candidate RMSI periodicities; or
output the control message comprising a two bit field that indicates the dynamic RMSI periodicity from the set of candidate RMSI periodicities, the set of candidate RMSI periodicities comprising four candidate RMSI periodicities.

12. The network entity of claim 10, wherein the set of candidate RMSI periodicities is based at least in part on an operating frequency band associated with the RMSI or a multiplexing pattern associated with synchronization signal blocks.

13. The network entity of claim 10, wherein:
the control message is a master information block,
the master information block indicates first scheduling information for a physical downlink control channel transmission, and, and
the physical downlink control channel transmission indicates second scheduling information for the first RMSI message.

14. The network entity of claim 9, wherein the dynamic RMSI periodicity is based at least in part on an operating frequency band associated with the RMSI or a multiplexing pattern associated with synchronization signal blocks.

15. A user equipment (UE), comprising:
one or more memories storing processor-executable code; and
one or more processors coupled with the one or more memories and individually or collectively operable to execute the code to cause the UE to:
receive remaining minimum system information (RMSI) via a first RMSI message during a first RMSI period in accordance with an RMSI periodicity;
receive the RMSI via a second RMSI message during a second RMSI period in accordance with the RMSI periodicity, wherein the second RMSI period is subsequent to and contiguous with the first RMSI period;
receive a control message that indicates that the first RMSI period is bundled with the second RMSI period; and
decode the RMSI from the first RMSI message and the second RMSI message based at least in part on the control message.

16. The UE of claim 15, wherein, to receive the control message, the one or more processors are individually or collectively operable to execute the code to cause the UE to:
receive the control message during the first RMSI period, wherein the control message comprises a field that indicates that the first RMSI period is bundled with a subsequent and contiguous RMSI period.

17. The UE of claim 16, wherein the one or more processors are individually or collectively further operable to execute the code to cause the UE to:
receive a plurality of control messages during the first RMSI period, wherein the plurality of control messages indicate respective scheduling information for a plurality of respective RMSI messages during the first RMSI period, wherein the plurality of respective RMSI messages comprises the first RMSI message, and wherein the control message is a temporally last control message of the plurality of control messages.

18. The UE of claim 16, wherein the control message comprises one of downlink control information that indicates scheduling information for the first RMSI period or a master information block.

19. The UE of claim 15, wherein, to receive the control message, the one or more processors are individually or collectively operable to execute the code to cause the UE to:
receive the control message during the second RMSI period, wherein the control message comprises a field that indicates that the second RMSI period is bundled with a prior and contiguous RMSI period.

20. The UE of claim 19, wherein the one or more processors are individually or collectively further operable to execute the code to cause the UE to:
receive a plurality of control messages during the second RMSI period, wherein the plurality of control messages indicate respective scheduling information for a plurality of respective RMSI messages during the second RMSI period, wherein the plurality of respective RMSI messages comprises the first RMSI message, and wherein the control message is a temporally first control message of the plurality of control messages.

21. The UE of claim 19, wherein the control message comprises one of downlink control information that indicates scheduling information for the second RMSI period or a master information block.

22. The UE of claim 15, wherein, to receive the control message, the one or more processors are individually or collectively operable to execute the code to cause the UE to:
receive second downlink control information that includes second scheduling information for the second RMSI message, wherein a second new data indicator field of the second downlink control information indicates a same value as a first new data indicator field of first downlink control information that includes first scheduling information for the first RMSI message.

23. The UE of claim 15, wherein the one or more processors are individually or collectively further operable to execute the code to cause the UE to:
receive, during one of the first RMSI period or the second RMSI period, a plurality of control messages, wherein the plurality of control messages comprises the control message, and wherein each of the plurality of control messages indicates that the first RMSI period is bundled with the second RMSI period or each of the plurality of control messages indicates that the first RMSI period is not bundled with the second RMSI period.

24. The UE of claim 15, wherein decoding the RMSI from the first RMSI message and the second RMSI message is based at least in part on an operating frequency band associated with the RMSI or a multiplexing pattern associated with synchronization signal blocks.

25. The UE of claim 15, wherein, to decode the RMSI, the one or more processors are individually or collectively operable to execute the code to cause the UE to:
perform a soft combination of a first set of coded bits associated with the first RMSI message and a second set of coded bits associated with the second RMSI message.

26. The UE of claim 15, wherein the first RMSI message and the second RMSI message are associated with a same payload based at least in part on the control message.

27. A network entity, comprising:
one or more memories storing processor-executable code; and
one or more processors coupled with the one or more memories and individually or collectively operable to execute the code to cause the network entity to:
output, to a user equipment (UE), a remaining minimum system information (RMSI) via a first RMSI message during a first RMSI period in accordance with an RMSI periodicity;
output, to the UE, the RMSI via a second RMSI message during a second RMSI period in accordance with the RMSI periodicity, wherein the second RMSI period is subsequent to and contiguous with the first RMSI period; and
transmit, to the UE, a control message that indicates that the first RMSI period is bundled with the second RMSI period, wherein the first RMSI message has a same payload as the second RMSI message based at least in part on the control message.

28. The network entity of claim 27, wherein, to output the control message, the one or more processors are individually or collectively operable to execute the code to cause the network entity to:
output the control message during the first RMSI period, wherein the control message comprises a field that indicates that the first RMSI period is bundled with a subsequent and contiguous RMSI period.

29. The network entity of claim 28, wherein the one or more processors are individually or collectively further operable to execute the code to cause the network entity to:
output a plurality of control messages during the first RMSI period, wherein the plurality of control messages indicate respective scheduling information for a plurality of respective RMSI messages during the first RMSI period, wherein the plurality of respective RMSI messages comprises the first RMSI message, and wherein the control message is a temporally last control message of the plurality of control messages.

30. The network entity of claim 27, wherein, to output the control message, the one or more processors are individually or collectively operable to execute the code to cause the network entity to:
output the control message during the second RMSI period, wherein the control message comprises a field that indicates that the second RMSI period is bundled with a prior and contiguous RMSI period.
